(19) United States
(12) Patent Application Publication
(10) Pub. No.: US 2002/0111800 A1
(43) Pub. Date: Aug. 15, 2002

(54) Voice encoding and voice decoding apparatus

(76) Inventors: Masanao Suzuki, Kawasaki (JP); Yasuji Ota, Kawasaki (JP); Yoshiteru Tsuchinaga, Fukuoka (JP)

Correspondence Address: Rosenman & Colin LLP, 575 Madison Avenue, New York, NY, 10022-2585, US

(21) Appl. No.: 10/046,125

(22) Filed: Jan. 8, 2002

Related U.S. Application Data
(63) Continuation of application No. PCT/JP99/04991, filed on Sep. 14, 1999.

(51) Int. Cl. G10L 19/10; G10L 19/08; G10L 19/04

(52) U.S. Cl. 704/220

(57) ABSTRACT

Disclosed is a voice encoding method having a synthesis filter implemented using linear prediction coefficients obtained by dividing an input signal into frames each of a fixed length, and subjecting the input signal to linear prediction analysis in the frame units, generating a reconstructed signal by driving said synthesis filter by a periodicity signal output from an adaptive codebook and a pulsed signal output from an algebraic codebook, and performing encoding in such a manner that an error between the input signal and said reproduced signal is minimized, wherein there are provided an encoding mode 1 that uses pitch lag obtained from an input signal of a present frame and an encoding mode 2 that uses pitch lag obtained from an input signal of a past frame. Encoding is performed in encoding mode 1 and encoding mode 2, the mode in which the input signal can be encoded more precisely is decided frame by frame and encoding is carried out on the basis of the mode decided.

### BACKGROUND OF THE INVENTION

This invention relates to a voice encoding and voice decoding apparatus for encoding/decoding voice at a low bit rate of below 4 kbps. More particularly, the invention relates to a voice encoding and voice decoding apparatus for encoding/decoding voice at low bit rates using an A-b-S (Analysis-by-Synthesis)-type vector quantization. It is expected that A-b-S voice encoding typified by CELP (Code Excited Linear Predictive Coding) will be an effective scheme for implementing highly efficient compression of information while maintaining speech quality in digital mobile communications and intercorporate communications systems.

In the field of digital mobile communications and intercorporate communications systems at the present time, it is desired that voice in the telephone band (0.3 to 3.4 kHz) be encoded at a transmission rate on the order of 4 kbps. The scheme referred to as CELP (Code Excited Linear Prediction) is seen as having promise in filling this need. For details on CELP, see M. R. Schroeder and B. S. Atal, “Code-Excited Linear Prediction (CELP): High-Quality Speech at Very L₀ w Bit Rates,” Proc. ICASSP'85, 25.1.1, pp. 937-940, 1985. CELP is characterized by the efficient transmission of linear prediction coefficients (LPC coefficients), which represent the speech characteristics of the human vocal tract, and parameters representing a sound-source signal comprising the pitch component and noise component of speech.

FIG. 15 is a diagram illustrating the principles of CELP. In accordance with CELP, the human vocal tract is approximated by an LPC synthesis filter H(z) expressed by the following equation:

$$H ( z ) = \frac{1}{1 + {\sum }_{i = 1}^{p} {a}_{i} {z}^{- i}} \qquad ( 1 )$$

and it is assumed that the input (sound-source signal) to H(z) can be separated into (1) a pitch-period component representing the periodicity of speech and (2) a noise component representing randomness. CELP, rather than transmitting the input voice signal to the decoder side directly, extracts the filter coefficients of the LPC synthesis filter and the pitch-period component and noise component of the excitation signal, quantizes these to obtain quantization indices and transmits the quantization indices, thereby implementing a high degree of information compression.

When the voice signal is sampled at a predetermined speed in FIG. 15, input signals (voice signals) X of a predetermined number (=N) of samples per frame are input to an LPC analyzer 1 frame by frame. If the sampling speed is 8 kHz and the period of a single frame is 10 ms, then one frame is composed of 80 samples.

The LPC analyzer 1, which is regarded as an all-pole filter represented by Equation (1), obtains filter coefficients αᵢ (i=1, . . . , p), where p represents the order of the filter. Generally, in the case of voice in the telephone band, a value of 10 to 12 is used as p. LPC coefficients αᵢ (i=1, . . . , p) are quantized by scalar quantization or vector quantization in an LPC-coefficient quantizer 2, after which the quantization indices are transmitted to the decoder side. FIG. 16 is a diagram useful in describing the quantization method. Here sets of large numbers of quantization LPC coefficients have been stored in a quantization table 2a in correspondence with index numbers 1 to n. A distance calculation unit 2b calculates distance in accordance with the following equation:

d=W·Σᵢ{_{q}(i)−αᵢ}² (i=1˜p)

When q is varied from 1 to n, a minimum-distance index detector 2c finds the q for which the distance d is minimum and sends the index q to the decoder side. In this case, an LPC synthesis filter constituting an auditory weighting synthesis filter 3 is expressed by the following equation:

$${H}_{q} ( z ) = \frac{1}{1 + {\sum }_{i = 1}^{p} {α}_{i} ( i ) {z}^{- i}} \qquad ( 2 )$$

Next, quantization of the sound-source signal is carried out. In accordance with CELP, a sound-source signal is divided into two components, namely a pitch-period component and a noise component, an adaptive codebook 4 storing a sequence of past sound-source signals is used to quantize the pitch-period component and an algebraic codebook or noise codebook is used to quantize the noise component. Described below will be typical CELP-type voice encoding using the adaptive codebook 4 and algebraic codebook 5 as sound-source codebooks.

The adaptive codebook 4 is adapted to successively output N samples of sound-source signals (referred to as “periodicity signals”), which are delayed by one pitch (one sample), in association with indices 1 to L. FIG. 17 is a diagram showing the structure of the adaptive codebook 4 in case of L=147, one frame, 80 samples (N=80). The adaptive codebook is constituted by a buffer BF for storing the pitch-period component of the latest 227 samples. A periodicity signal comprising 1 to 80 samples is specified by index 1, a periodicity signal comprising 2 to 81 samples is specified by index 2, . . . , and a periodicity signal comprising 147 to 227 samples is specified by index 147.

An adaptive-codebook search is performed in accordance with the following procedure: First, a bit lag L representing lag from the present frame is set to an initial value L₀ (e.g., 20). Next, a past periodicity signal (adaptive code vector) P_{L}, which corresponds to the lag L, is extracted from the adaptive codebook 4. That is, an adaptive code vector P_{L} indicated by index L is extracted and PL is input to the auditory weighting synthesis filter 3 to obtain an output AP_{L}, where A represents the impulse response of the auditory weighting synthesis filter 3 constructed by cascade connecting an auditory weighting filter W(z) and an LPC synthesis filter Hq(z).

Any filter can be used as the auditory weighting filter. For example, it is possible to use a filter having the characteristic indicated by the following equation:

$$W ( z ) = \frac{1 + {\sum }_{i = 1}^{m} {g}_{1}^{i} {α}_{i} {z}^{- 1}}{1 + {\sum }_{i = 1}^{m} {g}_{2}^{i} {α}_{i} {z}^{- 1}} \qquad ( 3 )$$

where g₁, g₂ are parameters for adjusting the characteristic of the weighting filter.

An arithmetic unit 6 finds an error power EL between the input voice and AP_{L} in accordance with the following equation:

E_{L}=|X-βAP_{L}|¹ (4)

If we let AP_{L} represent a weighted synthesized output from the adaptive codebook, Rpp the autocorrelation of AP_{L} and Rxp the cross-correlation between AP_{L} and the input signal X, then an adaptive code vector P_{L} at a pitch lag Lopt for which the error power of Equation (4) is minimum will be expressed by the following equation:

$$\begin{matrix}{P}_{L} = arg max ( \frac{{R}^{2} xp}{Rpp} ) \\ = arg max [ \frac{{( {X}^{T} {AP}_{L} )}^{2}}{{( {AP}_{L} )}^{T} ( {AP}_{L} )} ]\end{matrix} \qquad ( 5 )$$

where T signifies a transposition. Accordingly, an error-power evaluation unit 7 finds the pitch lag Lopt that satisfies Equation (5). Optimum pitch gain βopt is given by the following equation:

βopt=Rxp/Rpp (6)

Though the search range of lag L is optional, the lag range can be made 20 to 147 in a case where the sampling frequency of the input signal is 8 kHz.

Next, the noise component contained in the sound-source signal is quantized using the algebraic codebook 5. The algebraic codebook 5 is constituted by a plurality of pulses of amplitude 1 or −1. By way of example, FIG. 18 illustrates pulse positions for a case where frame length is 40 samples. The algebraic codebook 5 divides the N (=40) sampling points constituting one frame into a plurality of pulse-system groups 1 to 4 and, for all combinations obtained by extracting one sampling point from each of the pulse-system groups, successively outputs, as noise components, pulsed signals having a +1 or a −1 pulse at each extracted sampling point. In this example, basically four pulses are deployed per frame. FIG. 19 is a diagram useful in describing sampling points assigned to each of the pulse-system groups 1 to 4.

(1) Eight sampling points 0, 5, 10, 15, 20, 25, 30, 35 are assigned to the pulse-system group 1;

(2) eight sampling points 1, 6, 11, 16, 21, 26, 31, 36 are assigned to the pulse-system group 2;

(3) eight sampling points 2, 7, 12, 17, 22, 27, 32, 37 are assigned to the pulse-system group 3; and

(4) 16 sampling points 3, 4, 8, 9, 13, 14, 18, 19, 23, 24, 28, 29, 33, 34, 38, 39 are assigned to the pulse-system group 4.

Three bits are required to express one of the sampling points in pulse-system groups 1 to 3 and one bit is required to express the sign of a pulse, for a total of four bits. Further, four bits are required to express one of the sampling points in pulse-system group 4 and one bit is required to express the sign of a pulse, for a total of five bits. Accordingly, 17 bits are necessary to specify a pulsed signal output from the algebraic codebook 5 having the pulse placement of FIG. 18, and 21 (=2⁴^{×2}⁴×2⁴×2⁵) types of pulsed signals exist.

The algebraic codebook search will now be described with regard to this example. The pulse positions of each of the pulse systems group are limited as illustrated in FIG. 18. In the algebraic codebook search, a combination of pulses for which the error power relative to the input voice is minimized in the reconstruction region is decided from among the combinations of pulse positions of each of the pulse systems. More specifically, with βopt as the optimum pitch gain found by the adaptive codebook search, the output PL of the adaptive codebook is multiplied by the gain βopt and the product is input to an adder 8. At the same time, the pulsed signals are input successively to the adder 8 from the algebraic codebook 5 and a pulsed signal is specified that will minimize the difference between the input signal X and a reconstructed signal obtained by inputting the adder output to the weighting synthesis filter 3.

More specifically, first a target vector X′ for an algebraic codebook search is generated in accordance with the following equation from the optimum adaptive codebook output P_{L} and optimum pitch gain βopt obtained from the input signal X by the adaptive codebook search:

X′=X−βoptAP_{L} (7)

In this example, pulse position and amplitude (sign) are expressed by 17 bits and therefore 2¹⁷ combinations exist, as mentioned above. Accordingly, letting C_{K} represent a kth algebraic-code output vector, a code vector C_{K} that will minimize an evaluation-function error output power D in the following equation is found by a search of the algebraic codebook:

D=|X′−γAC_{K}|² (8)

where γ represents the gain of the algebraic codebook. Minimizing Equation (8) is equivalent to finding the C_{K}, i.e., the k, that will minimize the following equation:

$${D}^{′} = \frac{{( {X}^{′ T} A {C}_{k} )}^{2}}{{( A {C}_{k} )}^{T} ( A {C}_{k} )} \qquad ( 9 )$$

The error-power evaluation unit 7 searches for k as set forth below.

If we let Φ=A^{T}A, d=X′^{T}A hold, then the above will be expressed as follows:

$${D}^{′} = \frac{{( d {C}_{k} )}^{2}}{{C}_{k}^{T} Φ {C}_{k}} = \frac{{Q}_{k}^{2}}{{E}_{k}} \qquad ( 10 )$$

If we let the elements of the impulse response be a(0), a(1), . . . , a(N-1) and let the elements of the target signal X′ be x′ (0), x′ (1), . . . , x′ (N-1), then d will be expressed by the following equation, where N is the frame length:

$$d ( n ) = {\sum }_{i = n}^{N - 1} {x}^{′} ( i ) a ( i - n ) , n = 0 , … , N - 1 \qquad ( 11 )$$

Further, an element φ(i,j) of Φ is represented by the following equation:

$$φ ( i , j ) = {\sum }_{n = j}^{N - 1} a ( n - i ) a ( n - j ) , \\ i = 0 … , N - 1 , j = i , … , N - 1 \qquad ( 12 )$$

It should be noted that d(n) and +(i,j) are calculated before the search of the algebraic codebook.

If we let Np represent the number of pulses contained in the output vector Cₖ of the algebraic codebook 5, then Qₖ in the numerator of Equation (1) is represented by the following equation:

$${Q}_{k} = {\sum }_{i = 0}^{N - 1} {s}_{k} ( i ) d [ {m}_{k} ( i ) ] \qquad ( 13 )$$

where Sₖ (i) is the pulse amplitude (+1 or −1) in the ith pulse system of Cₖ and mₖ (i) represents the position of the pulse. Further, the denominator Eₖ of Equation (10) is found by the following equation:

$${E}_{k} = {\sum }_{i = 0}^{N - 1} φ [ {m}_{k} ( i ) , {m}_{k} ( i ) ] + 2 {\sum }_{i = 0}^{N - 2} {\sum }_{j = i + 1}^{N - 1} {s}_{k} ( i ) {s}_{k} ( j ) φ [ {m}_{k} ( i ) , {m}_{k} ( j ) ] \qquad ( 14 )$$

It is also possible to conduct a search using Qₖ in Equation (13) and Eₖ in Equation (14). However, in order to reduce the amount of processing involved in the search, Qₖ and Eₖ are transformed through the following procedure: First, d(n) is split into two portions, namely its absolute value |d(n)|and sign sign[d(n)]. Next, the sign information of d(n) is included in Φ by the following equation:

φ′(i,j)=sign[d(i)]sign[d(j)]φ(i,j), i=0, . . . N-1, j=i+1, . . . N-1 (15)

In order to eliminate the constant 2 in the second term of Equation (14), the main diagonal component of Φ is scaled by the following equation:

φ′(i,i)=φ′(i,i)/2, i=0, N-1 (16)

Accordingly, the numerator Qₖ is simplified as indicated by the following equation:

$${Q}_{k}^{′} = {\sum }_{i = 0}^{N - 1} \vert d [ {m}_{k} ( i ) ] \vert \qquad ( 17 )$$

Further, the denominator Eₖ is simplified as indicated by the following equation:

$$\begin{matrix}{E}_{k}^{′} = {E}_{k} / 2 \\ = {\sum }_{i = 0}^{N - 1} {φ}^{′} [ {m}_{k} ( i ) , {m}_{k} ( i ) ] + {\sum }_{i = 0}^{N - 2} {\sum }_{j = i + 1}^{N - 1} {s}_{k} ( i ) {s}_{k} ( j ) {φ}^{′} [ {m}_{k} ( i ) , {m}_{k} ( j ) ]\end{matrix} \qquad ( 18 )$$

Accordingly, the output of the algebraic codebook can be obtained by calculating the numerator Qₖ ′and denominator Eₖ ′in accordance with Equations (17), (18) while changing the position of each pulse, and deciding the pulse position for which D″=Qₖ′²/Eₖ ′is maximized.

Next, quantization of the gains αopt, γopt is carried out. The gain quantization method is optional and a method such as scalar quantization or vector quantization can be used. For example, it is so arranged that β, γ are quantized and the quantization indices of the gain are transmitted to the decoder through a method similar to that employed by the LPC-coefficient quantizer 2.

Thus, an output information selector 9 sends the decoder (1) the quantization index of the LPC coefficient, (2) pitch lag L₀ pt, (3) an algebraic codebook index (pulsed-signal specifying data), and (4) a quantization index of gain.

Further, after all search processing and quantization processing in the present frame is completed, and before the input signal of the next frame is processed, the state of the adaptive codebook 4 is updated. In state updating, a frame length of the sound-source signal of the oldest frame (the frame farthest in the past) in the adaptive codebook is discarded and a frame length of the latest sound-source signal found in the present frame is stored. It should be noted that the initial state of the adaptive codebook 4 is the zero state, i.e., a state in which the amplitudes of all samples are zero.

Thus, as described above, the CELP system produces a model of the speech generation process, quantizes the characteristic parameters of this model and transmits the parameters, thereby making it possible to compress speech efficiently.

It is known that CELP (and improvements therein) makes it possible to realize high-quality reconstructed speech at a bit rate on the order of 8 to 16 kbps. Among these schemes, ITU-T Recommendation G.729A (CS-ACELP) makes it possible to achieve a sound quality equal to that of 32-kbps ADPCM on the condition of a low bit rate of 8 kbps. From the standpoint of effective utilization of the communication channel, however, there is now a need to implement high-quality reconstructed speech at a very low bit rate of less than 4 kbps.

The simplest method of reducing bit rate is to raise the efficiency of vector quantization by increasing frame length, which is the unit of encoding. The CS-ACELP frame length is 5 ms (40 samples) and, as mentioned above, the noise component of the sound-source signal is vector-quantized at 17 bits per frame. Consider a case where frame length is made 10 ms (=80 samples), which is twice that of CS-ACELP, and the number of quantization bits assigned to the algebraic codebook per frame is 17.

FIG. 20 illustrates an example of pulse placement in a case where four pulses reside in a 10-ms frame. The pulses (sampling points and polarities) of first to third pulse systems in FIG. 20 are each represented by five bits and the pulses of a fourth pulse system are represented by six bits, so that 21 bits are necessary to express the indices of the algebraic codebook. That is, in a case where the algebraic codebook is used, if frame length is simply doubled to 10 ms, the combinations of pulses increase by an amount commensurate with the increase in positions at which pulses reside unless the number of pulses per frame is reduced. As a consequence, the number of quantization bits also increases.

In the case of this example, the only method available to make the number of bits of the algebraic codebook indices equal to 17 is to reduce the number of pulses, as illustrated in FIG. 21 by way of example. However, on the basis of experiments performed by the Inventor, it has been found that the quality of reconstructed speech deteriorates markedly when the number of pulses per frame is made three or less. This phenomenon can be readily understood qualitatively. Specifically, if there are four pulses per frame (FIG. 18) in a case where the frame length is 5 ms, then eight pulses will be present in 10 ms. By contrast, if there are three pulses per frame (FIG. 21) in a case where the frame length is 10 ms, then naturally only three pulses will be present in 10 ms. As a consequence, the noise property of the sound-source signal to be represented in the algebraic codebook cannot be expressed and the quality of reconstructed speech declines.

Thus, even if frame length is enlarged to reduce the bit rate, the bit rate cannot be reduced unless the number of pulses per frame is reduced. If the number of pulses is reduced, however, the quality of reconstructed speech deteriorates by a wide margin. Accordingly, with the method of raising the efficiency of vector quantization simply by increasing frame length, achieving high-quality reconstructed speed at a bit rate of 4 kbps is difficult.

### SUMMARY OF THE INVENTION

Accordingly, an object of the present invention is to make it possible to reduce the bit rate and reconstruct high-quality speech.

In CELP, an encoder sends a decoder (1) a quantization index of an LPC coefficient, (2) pitch lag Lopt of an adaptive codebook, (3) an algebraic codebook index (pulsed-signal specifying data), and (4) a quantization index of gain. In this case, eight bits are necessary to transmit the pitch lag. If pitch lag need not be sent, therefore, the number of bits used to express the algebraic codebook index can be increased commensurately. In other words, the number of pulses contained in the pulsed signal output from the algebraic codebook can be increased and it therefore becomes possible to transmit high-quality voice code and to achieve high-quality reproduction. It is generally known that a steady segment of speech is such that the pitch period varies slowly. The quality of reconstructed speech will suffer almost no deterioration in the steady segment even if pitch lag of the present frame is regarded as being the same as pitch lag in a past (e.g., the immediately preceding) frame.

According to the present invention, therefore, there are provided an encoding mode 1 that uses pitch lag obtained from an input signal of a present frame and an encoding mode 2 that uses pitch lag obtained from an input signal of a past frame, a first algebraic codebook having a small number of pulses is used in the encoding mode 1 and a second algebraic codebook having a large number of pulses is used in the encoding mode 2. When encoding is performed, an encoder carries out encoding frame by frame in each of the encoding modes 1 and 2 and sends a decoder a code obtained by encoding an input signal in whichever mode enables more accurate reconstruction of the input signal. If this arrangement is adopted, the bit rate can be reduced and it becomes possible to reconstruct high-quality speech.

Further, there are provided an encoding mode 1 that uses pitch lag obtained from an input signal of a present frame and an encoding mode 2 that uses pitch lag obtained from an input signal of a past frame, a first algebraic codebook having a small number of pulses is used in the encoding mode 1 and a second algebraic codebook in which the number of pulses is greater than that of the first algebraic codebook is used in the encoding mode 2. When encoding is performed, the optimum mode is decided based upon a property of the input signal, e.g., the periodicity of the input signal, and encoding is carried out on the basis of the mode decided. If this arrangement is adopted, the bit rate can be reduced and it becomes possible to reconstruct high-quality speech.

### BRIEF DESCRIPTION OF THE DRAWINGS

FIG. 1 is a diagram useful in describing a first overview of the present invention;

FIG. 2 shows an example of placement of pulses in an algebraic codebook 0;

FIG. 3 shows an example of placement of pulses in an algebraic codebook 1;

FIG. 4 is a diagram useful in describing a second overview of the present invention;

FIG. 5 shows an example of placement of pulses in an algebraic codebook 2;

FIG. 6 is a block diagram of a first embodiment of an encoding apparatus;

FIG. 7 is a block diagram of a second embodiment of an encoding apparatus;

FIG. 8 shows the processing procedure of a mode decision unit;

FIG. 9 is a block diagram of a third embodiment of an encoding apparatus;

FIG. 10 shows an example of placement of pulses in each algebraic codebook used in the third embodiment;

FIG. 11 is a conceptual view of pitch periodization;

FIG. 12 is a block diagram of a fourth embodiment of an encoding apparatus;

FIG. 13 is a block diagram of a first embodiment of a decoding apparatus;

FIG. 14 is a block diagram of a second embodiment of a decoding apparatus;

FIG. 15 is a diagram showing the principle of CELP;

FIG. 16 is a diagram useful in describing a quantization method;

FIG. 17 is a diagram useful in describing an adaptive codebook;

FIG. 18 shows an example of pulse placement of an algebraic codebook;

FIG. 19 is a diagram useful in describing sampling points assigned to each pulse-system group;

FIG. 20 shows an example of a case where four pulses reside in a 10-ms frame; and

FIG. 21 shows an example of a case where three pulses reside in a 10-ms frame.

### DESCRIPTION OF THE PREFERED EMBODIMENTS

(A) Overview of the Present Invention

(a) First Characterizing Feature

The present invention provides a first encoding mode (mode 0), which uses pitch lag obtained from an input signal of a present frame, as pitch lag of a present frame and uses an algebraic codebook of a small number of pulses and a second encoding mode (mode 1) that uses pitch lag obtained from an input signal of a past frame, e.g., the immediately preceding frame, and uses an algebraic codebook, the number of pulses of which is greater than that of the algebraic codebook used in mode 0. The mode in which encoding is performed is decided depending upon which mode makes it possible to reconstruct speech faithfully. Since the number of pulses can be increased in mode 1, the noise component of a voice signal can be expressed more faithfully as compared with mode 0.

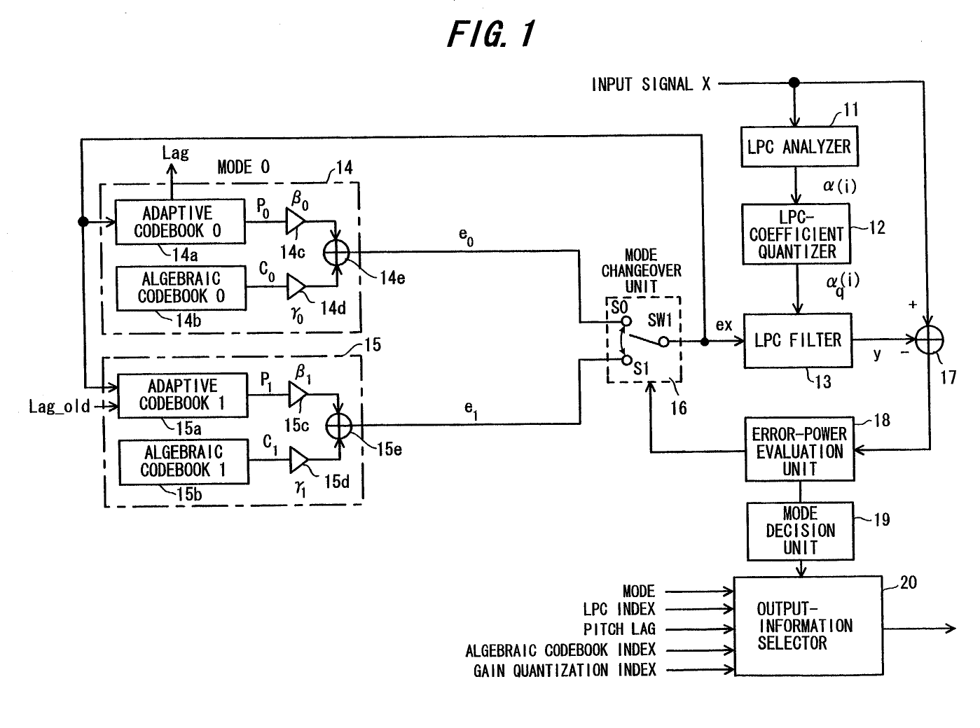

FIG. 1 is a diagram useful in describing a first overview of the present invention. An input signal vector x is input to an LPC analyzer 11 to obtain LPC coefficients α(i) (n=1, . . . , p), where p represents the order of LPC analysis. Here the number of dimensions of x is assumed to be the same as the number N of samples constituting a frame. Hereinafter the number of dimensions of a vector is assumed to be N unless specified otherwise. The LPC coefficients a(i) are quantized in an LPC-coefficients quantizer 12 to obtain quantized-LPC coefficients α_{q}(i) (n=1, . . . , p). An LPC synthesis filter 13 representing the speech characteristics of the human vocal tract in constituted by a(i) and the transfer function thereof is represented by the following equation:

$$H ( z ) = \frac{1}{1 + {\sum }_{i = 1}^{p} {α}_{q} ( i ) {z}^{- i}} \qquad ( 19 )$$

A first encoder 14 that operates in mode 0 has an adaptive codebook (adaptive codebook 0) 14a, an algebraic codebook (algebraic codebook 0) 14b, gain multipliers 14c, 14d and an adder 14e. A second encoder 15 that operates in mode 1 has an adaptive codebook (adaptive codebook 1) 15a, an algebraic codebook (algebraic codebook 1) 15b, gain multipliers 15c, 15d and an adder 15e.

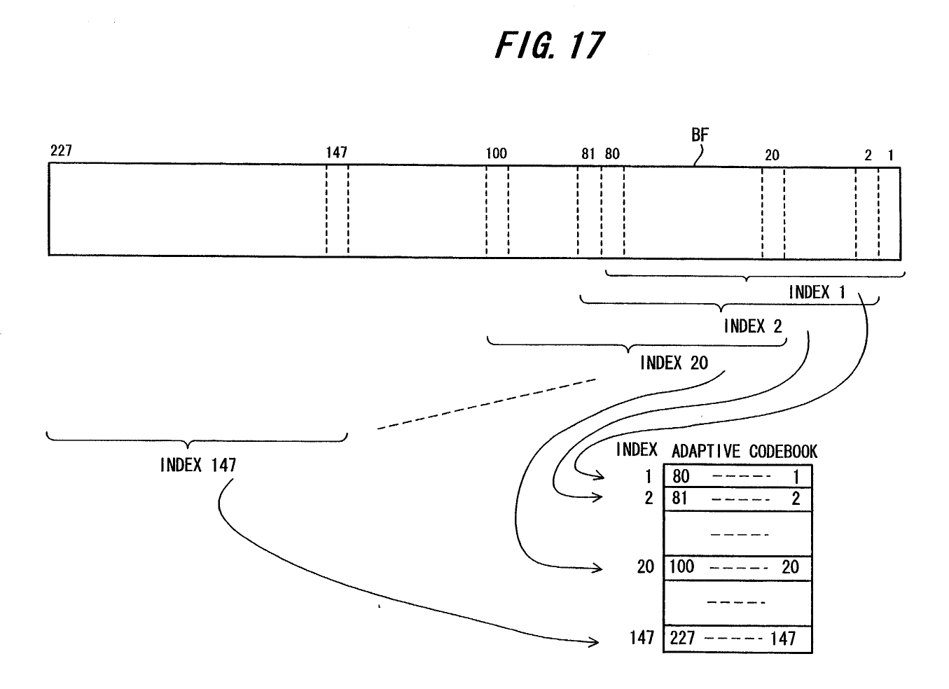

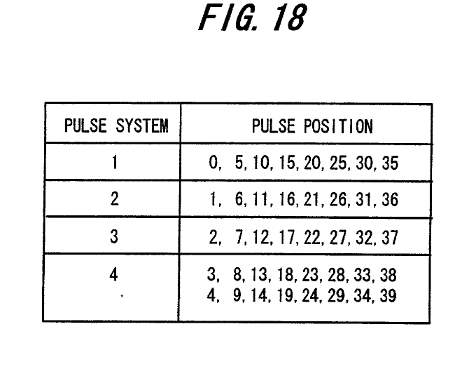

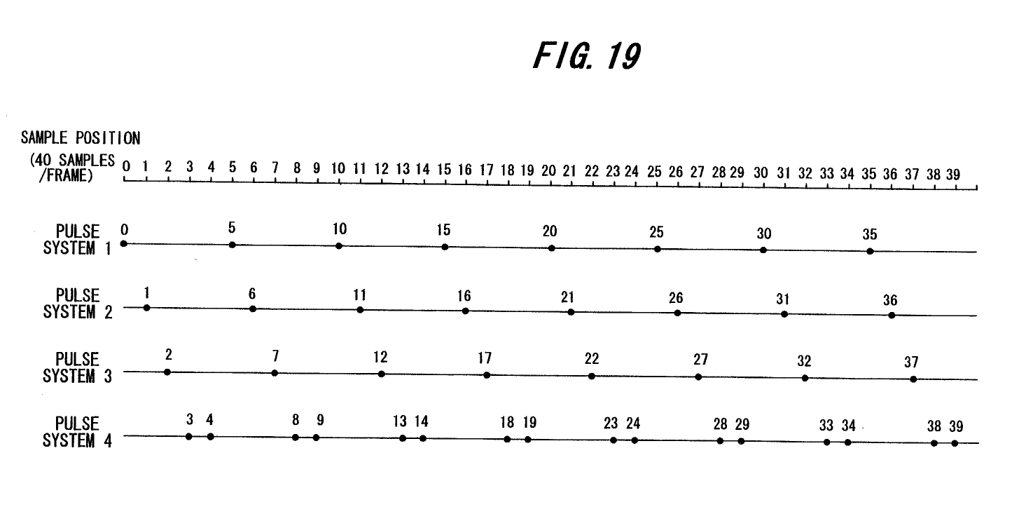

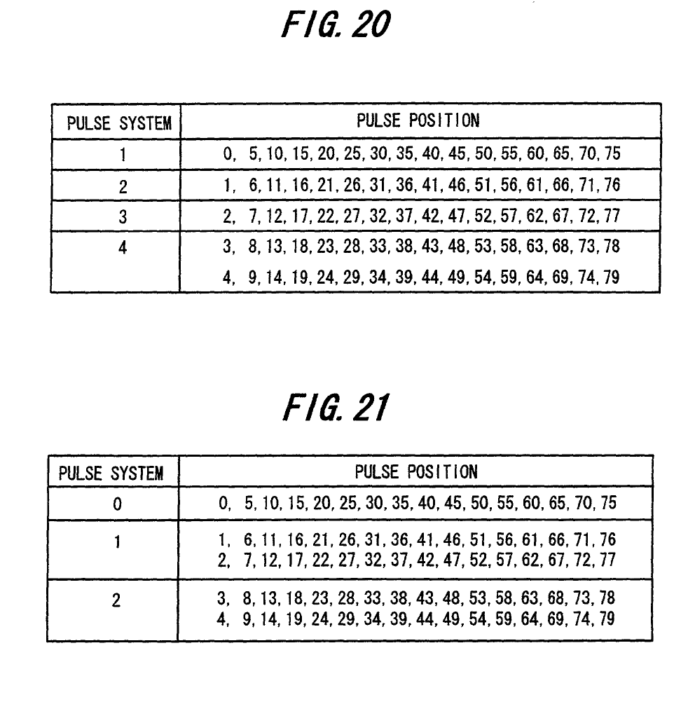

The adaptive codebooks 14a, 15a are implemented by buffers that store the pitch-period components of the latest n samples in the past, as described in conjunction with FIG. 17. The adaptive codebooks 14a, 15a are identical in content. If N=80 samples, n =227 hold, a sound-source signal (periodicity signal) comprising 1 to 80 samples is specified by pitch lag=1, a periodicity signal comprising 2 to 81 samples is specified by pitch lag=2, . . . , and a periodicity signal comprising 147 to 227 samples is specified by a pitch lag=147.

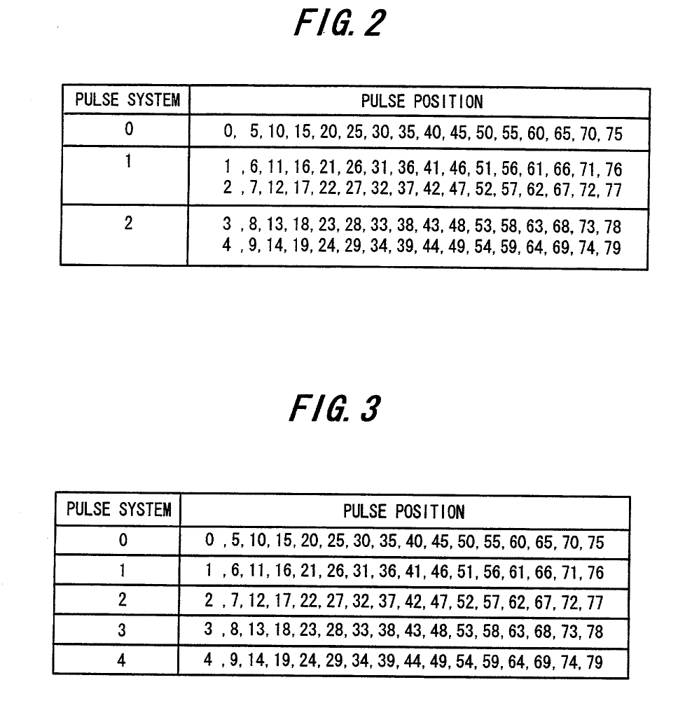

The placement of pulses of the algebraic codebook 14b in the first encoder 14 is as shown in FIG. 2. The algebraic codebook 14b divides the N (=80) sampling points constituting one frame into three pulse-system groups 0 to 2 and, for all combinations obtained by extracting one sampling point from each of the pulse-system groups, successively outputs, as noise components, pulsed signals having a pulse of a positive polarity or negative polarity at each extracted sampling point. Five bits are required to express the pulse positions and pulse polarities in each of the pulse-system groups 0, 1, and six bits are required to express the pulse positions and pulse polarities in the pulse-system group 2. Accordingly, a total of 17 bits are necessary to specify pulsed signals and the number m of combinations thereof is 217 (m=217).

The placement of pulses of the algebraic codebook 15b in the second encoder 15 is as shown in FIG. 3. The algebraic codebook 15b divides the N (=80) sampling points constituting one frame into five pulse-system groups 0 to 4 and, for all combinations obtained by extracting one sampling point from each of the pulse-system groups, successively outputs, as noise components, pulsed signals having a pulse of a positive polarity or negative polarity at each extracted sampling point. Five bits are required to express the pulse positions and pulse polarities in all of the pulse-system groups 0 to 4. A total of 25 bits are necessary to specify pulsed signals and the number m of combinations thereof is 2²⁵ (m=2²⁵).

The first encoder 14 has the same structure as that used in ordinary CELP, and the codebook search also is performed in the same manner as CELP. Specifically, pitch lag L is varied over a predetermined range (e.g., 20 to 147) in the first adaptive codebook 14a, adaptive codebook output P₀(L) at each pitch lag is input to the LPC filter 13 via a mode changeover unit 16, an arithmetic unit 17 calculates error power between the LPC synthesis filter output signal and the input signal x, and an error-power evaluation unit 18 finds an optimum pitch lag Lag and an optimum pitch gain β₀ for which error power is minimized. Next, a signal obtained by combining a signal, which is the result of multiplying by gain β₀ the adaptive codebook output indicated by the pitch lag Lag, and pulsed signal C₀(i) (i=0, . . . , m-1) output from the algebraic codebook 14b, is input to the LPC filter 13 via the mode changeover unit 16, the arithmetic unit 17 calculates the error power between the LPC synthesis filter output signal and the input signal x, and the error-power evaluation unit 18 decides an index I₀ and optimum algebraic codebook gain γ₀ that specify a pulsed signal for which the error power is smallest. Here m=2¹⁷ represents the size of the algebraic codebook 14b (the total number of combinations of pulses).

If the optimum codebook search and algebraic codebook search by the first encoder 14 are completed, the second encoder 15 starts the processing of mode 1. Mode 1 differs from mode 0 in that the adaptive codebook search is not conducted. It is generally known that a steady segment of speech is such that the pitch period varies slowly. The quality of reconstructed speech will suffer almost no deterioration in the steady segment even if pitch lag of the present frame is regarded as being the same as pitch lag in a past (e.g., the immediately preceding) frame. In such case it is unnecessary to send pitch lag to a decoder and hence leeway equivalent to the number of bits (e.g., eight) necessary to encode pitch lag is produced. Accordingly, these eight bits are used to express the index of the algebraic codebook. If this expedient is adopted, the placement of pulses in the algebraic codebook 15b can be made as shown in FIG. 3 and the number of pulses of the pulse signal can be increased. When the number of transmitted bits of an algebraic codebook (or noise codebook, etc.) is enlarged in CELP, a more complicated sound-source signal can be expressed and the quality of reconstructed speech is improved.

Thus, the second encoder 15 does not conduct an adaptive codebook search, regards optimum pitch lag lag_old, which was obtained in a past frame (e.g., the preceding frame), as optimum lag of the present frame and finds the optimum pitch gain β₁ prevailing at this time. Next, the second encoder 15 conducts an algebraic codebook search using the algebraic codebook 15b in a manner similar to that of the algebraic codebook search in the first encoder 14, and decides an optimum index Ii and optimum algebraic codebook gain γ₁ specifying a pulsed signal for which the error power is smallest.

If the search processing in the first and second encoders 14, 15 is completed, the sound-source signal vector of mode 0, namely

e₁=β₁·P₁(Lag_{—}old)+γ₁·C₁(I₁)

is found from the output vector P₀(lag) of the optimum adaptive codebook 14a decided in mode 0 and the output vector CO(IO) of the algebraic codebook 14b in mode 0. Similarly, the sound-source signal vector of mode 1, namely

e₁=β₁·P₁(Lag_old)+γ₁·C₁(I₁)

is found from the output vector P₀(lag_old) of the adaptive codebook decided in mode 1 and the output vector C₁(I₁) of the algebraic codebook 15b in mode 1. The error-power evaluation unit 18 calculates each error power between the sound-source vectors e₀, e₁ and input signal. A mode decision unit 19 compares the error power values that enter from the error-power evaluation unit 18 and decides the mode which will finally be used is that which provides the smaller error power. An output-information selector 20 selects, and transmits to the decoder, mode information, LPC quantization index, pitch lag and the algebraic codebook index and gain quantization index of the mode used.

At the end of all search processing and quantization processing of the present frame, the state of the adaptive codebook is updated before the input signal of the next frame is processed. In state updating, a frame length of the sound-source signal of the oldest frame (the frame farthest in the past) in the adaptive codebook is discarded and the latest sound-source signal eₓ (sound-source signal e₀ or e₁) found in the present frame is stored. It should be noted that the initial state of the adaptive codebook is assumed to be the zero state.

In the description rendered above, the mode finally used is decided after the adaptive codebook search/algebraic codebook search are conducted in all modes (modes 0, 1). However, it is possible to adopt an arrangement in which, prior to a search, the properties of the input signal are investigated, which mode is to be adopted is decided in accordance with these properties, and encoding is executed by conducting the adaptive codebook search/algebraic codebook search in whichever mode has been adopted. Further, the above description is rendered using two adaptive codebooks. However, since exactly the same past sound-source signals will have been stored in the two adaptive codebooks, implementation is permissible using one of the adaptive codebooks.

(b) Second Characterizing Feature

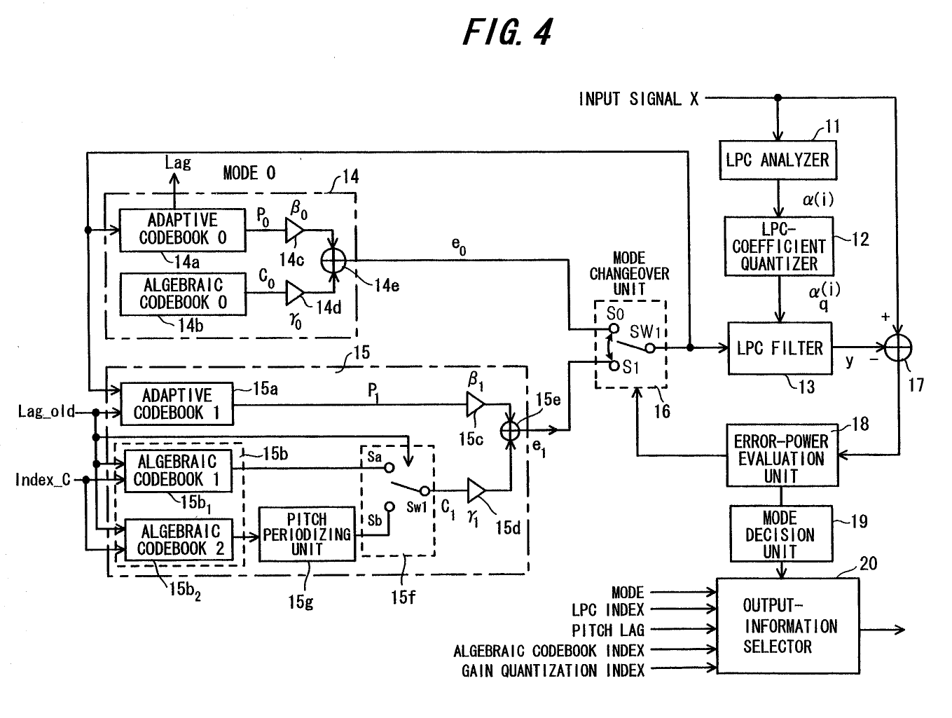

FIG. 4 is a diagram useful in describing a second overview of the present invention, in which components identical with those shown in FIG. 1 are designated by like reference characters. This arrangement differs in the construction of the second encoder 15.

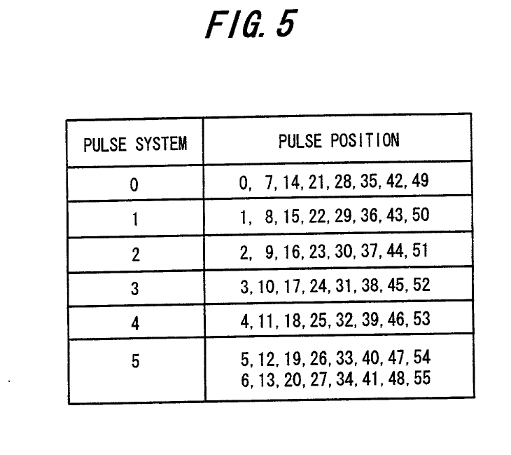

Provided as the algebraic codebook 15b of the second encoder 15 are (1) a first algebraic codebook 15b₁ and (2) a second algebraic codebook 15b₂ in which the number of pulses is greater than that of the first algebraic codebook 15b₁. The first algebraic codebook 15b₁ has the pulse placement shown in FIG. 3. The first algebraic codebook 15b₁ divides the N (=80) sampling points constituting one frame into a plurality (=5) of pulse-system groups and successively outputs pulsed signals having a pulse of a positive polarity or negative polarity at sampling points extracted one at a time from each of the pulse-system groups. On the other hand, as shown in FIG. 5, the second algebraic codebook 15b₂ divides M (=55) sampling points, which are contained in a period of time shorter than the duration of one frame, into a number (=6) of pulse-system groups greater than that of the first algebraic codebook 15b₁, and successively outputs pulsed signals having a pulse of a positive polarity or negative polarity at sampling points extracted one at a time from each of the pulse-system groups.

In mode 1, in which the value of pitch lag Lag_old found from the input signal of a past frame (e.g., the preceding frame) is used as the pitch lag of the present frame, an algebraic codebook changeover unit 15f selects the pulsed signal output of the first algebraic codebook 15b₁ if the value of Lag_old in the past is greater than M, and selects the pulsed signal output of the second algebraic codebook 15b₂ if the value of Lag old is less than M.

Since the second algebraic codebook 15b₂ places the pulses over a range narrower than that of the first algebraic codebook 15b₁, a pitch periodizing unit 15g executes pitch periodization processing for repeatedly outputting the pulsed signal pattern of the second algebraic codebook 15b₂.

Thus, in accordance with the present invention, as set forth above, there is provided, in addition to (1) the conventional CELP mode (mode 0), (2) a mode (mode 1) in which the amount of information for transmitting pitch lag is reduced by using past pitch lag and the amount of information of an algebraic codebook is increased correspondingly, thereby making it possible to obtain high-quality reconstructed voice in a steady segment of speech, such as a voiced segment. Further, by switching between mode 0 and mode 1 in dependence upon the properties of the input signal, it is possible to obtain high-quality reconstructed voice even with regard to input voice of various properties.

(B) First Embodiment of Voice Encoding Apparatus

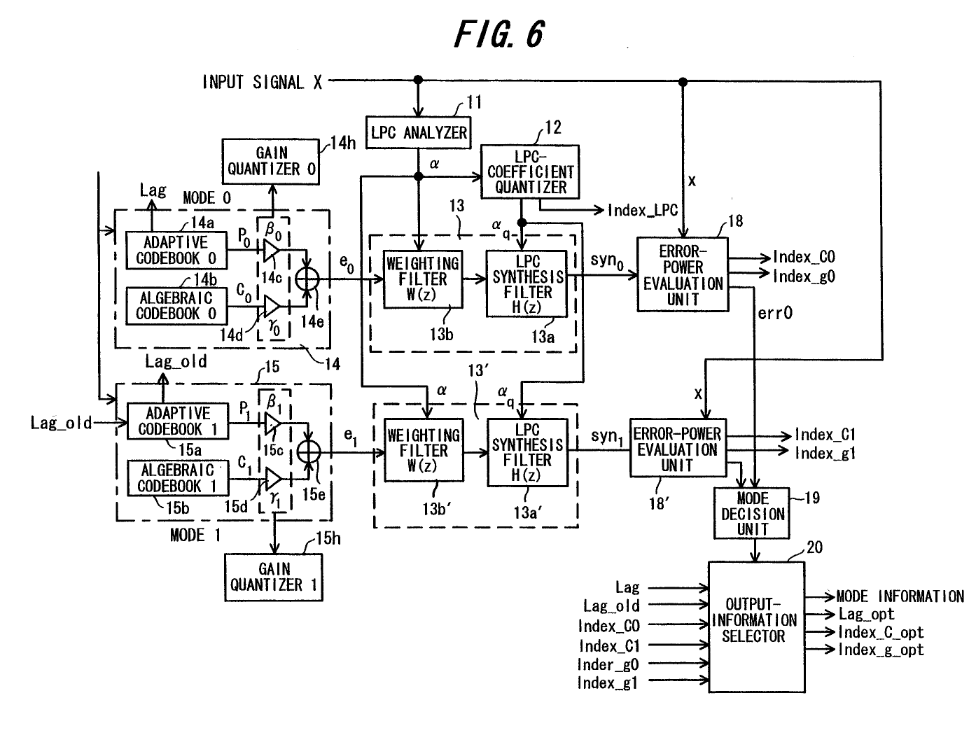

FIG. 6 is a block diagram of a first embodiment of a voice encoding apparatus according to the present invention. This apparatus has the structure of a voice encoder comprising two modes, namely mode 0 and mode 1.

The LPC analyzer 11 and LPC-coefficient quantizer 12, which are common to mode 0 and mode 1, will be described first. The input signal is divided into fixed-length frames on the order of 5 to 10 ms, and encoding processing is executed in frame units. It is assumed here that the number of samplings in one frame is N. The LPC analyzer (linear prediction analyzer) 11 obtains the LPC coefficients α={α(1), α(2), α(p)} from the input signal x of N samples in one frame.

Next, the LPC-coefficient quantizer 12 quantizes the LPC coefficients α and obtains an LPC quantization index Index_LPC and an inverse quantization value (quantized LPC coefficients) α_{q}={α_{q}1(1), α_{q}(2), . . ., α_{q}(p)} of the LPC coefficients. The gain quantization method is optional and a method such as scalar quantization or vector quantization can be used. Further, the LPC coefficients, rather than being quantized directly, may be quantized after first being converted to another parameter of superior quantization characteristic and interpolation characteristic, such as a k parameter (reflection coefficient) or LSP (line-spectrum pair). The transfer function H(z) of an LPC synthesis filter 13a constructing the auditory weighting LPC filter 13 is given by the following equation:

$$H ( z ) = \frac{1}{1 + {\sum }_{i = 1}^{p} {α}_{q} ( i ) {z}^{- i}} \qquad ( 20 )$$

It is possible for a filter of any type to be used as an auditory weighting filter 13b. A filter indicated by Equation (3) can be used.

The first encoder 14, which operates in accordance with mode 0, has the same structure as that used in ordinary CELP, includes the adaptive codebook 14a, algebraic codebook 14b, gain multipliers 14c, 14d, an adder 14e and a gain quantizer 14h, and obtains (1) optimum pitch lag Lag, (2) an algebraic codebook index index_C1 and (3) a gain index index_{—g}1. The search method of the adaptive codebook 14a and the search method of the algebraic codebook 14b in mode 0 are the same as the methods described in the section (A) above relating to an overview of the present invention.

In a case where the frame length is 10 ms (80 samples), the algebraic codebook 14b has a pulse placement of three pulses, as shown in FIG. 2. Accordingly, the output C₀(n) (n=0, . . . , N-1) of the algebraic codebook 14b is given by the following equation:

C₀(n)=s₀δ(n-m₁)+s₁δ(n-m₁) +s₂δ(n-m₂) (21)

where sᵢ represents the polarity (+1 or −1) of a pulse system i, mᵢ represents the pulse position of the pulse system i, and δ(0)=1 holds. The first term on the right side of Equation (21) signifies placement of pulse s₀ at pulse position m₀ in pulse-system group 0, the second term on the right side signifies placement of pulse s₁ at pulse position m₁ in pulse-system group 1, and the third term on the right side signifies placement of pulse S₂ at pulse position m₂ in pulse-system group 2. When the algebraic codebook search is conducted, the pulsed output signal of Equation (21) is output successively and a search is conducted for the optimum pulsed signal.

The gain quantizer 14h quantizes pitch gain an algebraic codebook gain. The quantization method is optional and a method such as scalar quantization or vector quantization can be used. If we let P₀ represent the output of the first adaptive codebook 14a decided in mode 0, C₀ the output of the algebraic codebook 14b, β₀ the quantized pitch gain and γ₀ the quantized gain of the algebraic codebook 14b, respectively, then the optimum sound-source vector e₀ of mode 0 will be given by the following equation:

e₀=P₀P₀+γ₀C₀ (22)

The sound-source vector e₀ is input to the weighting filter 13b and the output thereof is input to the LPC synthesis filter 13a, whereby a weighted synthesized output syn₀ is created. The error-power evaluation unit 18 of mode 0 calculates error power err0 between the input signal x and output syn₀ of the LPC synthesis filter and inputs the error power to the mode decision unit 19.

The adaptive codebook 15a does not execute search processing, regards optimum pitch lag lag_old, which was obtained in a past frame (e.g., the preceding frame), as optimum lag of the present frame and finds the optimum pitch gain β₁. The optimum pitch gain can be calculated in accordance with Equation (6). As mentioned earlier, it is unnecessary in mode 1 to transmit pitch lag to the decoder and, hence, the number of bits (e.g., eight bits per frame) required to transmit pitch lag can be allocated to quantization of the algebraic codebook index. As a result, though the algebraic codebook index must be expressed by 17 bits in mode 0, the algebraic codebook index can be expressed by 25 (=17+8) in mode 1. Accordingly, in a case where the length of one frame is 10 ms (80 samples), the number of pulses can be made 5 in the pulse placement of the algebraic codebook 15b, as shown in FIG. 3. The output C₁(n) (n=0, . . . , N-1) of the algebraic codebook 15b, therefore, is represented by the following equation:

$${C}_{1} ( n ) = {\sum }_{i = 0}^{4} {s}_{i} δ ( n - {m}_{i} ) \qquad ( 23 )$$

When a search of the algebraic codebook 15b is conducted, the algebraic codebook index Index_Cl and gain index Index_gl are obtained by successively outputting C₁(n) expressed by Equation (23). The method of searching the algebraic codebook 15b is the same as the method described in the section (A) above relating to an overview of the present invention.

If we let P₁ represent the output of the adaptive codebook 15a decided in mode 1, C₁ the output of the algebraic codebook 15b, β₁ the quantized pitch gain and γ₁, the quantized gain of the algebraic codebook 15b, respectively, then the optimum sound-source vector e₁ of mode 1 will be given by the following equation:

e₁=β₁P₁+γ₁C₁ (24)

The sound-source vector e₁ is input to a weighting filter 13b′ and the output thereof is input to an LPC synthesis filter 13a′, whereby a weighted synthesized output syn₁ is created. An error-power evaluation unit 18′ calculates error power err₁ between the input signal x and the weighted synthesized output syn₁ and inputs the error power to the mode decision unit 19.

The mode decision unit 19 compares err₀ and err₁ and decides that the mode which will finally be used is that which provides the smaller error power. The output-information selector 20 makes the mode information 0 if err0<err1 holds, makes the mode information 1 if err0>err1 holds, and selects a predetermined mode (0 or 1) if err0=err1 holds. Further, the output-information selector 20 selects pitch lag Lag_opt, the algebraic codebook index Index_C and the gain index Index_g on the basis of the mode used, adds the mode information and LPC index information onto these to create the final encoded data (transmit information), and transmits this information.

At the end of all search processing and quantization processing of the present frame, the state of the adaptive codebook is updated before the input signal of the next frame is processed. In state updating, the oldest frame (the frame farthest in the past) of the sound-source signal in the adaptive codebook is discarded and the latest sound-source signal eₓ (the above-mentioned e₀ or e₁) found in the present frame is stored. It should be noted that the initial state of the adaptive codebook is assumed to be the zero state, i.e., a state in which the amplitudes of all samples are zero.

In the embodiment of FIG. 6, use of the two adaptive codebooks 14a, 15a is described. However, since exactly the same past sound-source signals are stored in the two adaptive codebooks, implementation is permissible using one of the adaptive codebooks. Further, in the embodiment of FIG. 6, two weighting filters, two LPC synthesis filters and two error-power evaluation units are used. However, these pairs of devices can be united into single common devices.

Thus, in accordance with the first embodiment, there are provided (1) the conventional CELP mode (mode 0) and (2) a mode (mode 1) in which the pitch-lag information is reduced by using past pitch lag and the amount of information of an algebraic codebook is increased by the amount of reduction. As a result, in unsteady segments, such as unvoiced or transient segments, encoding processing the same as that of conventional CELP can be executed. In steady segments of speech such as voiced segments, on the other hand, the sound-source signal can be encoded precisely by mode 1, thereby making it possible to obtain high-quality reconstructed voice.

(C) Second Embodiment of Voice Encoding Apparatus

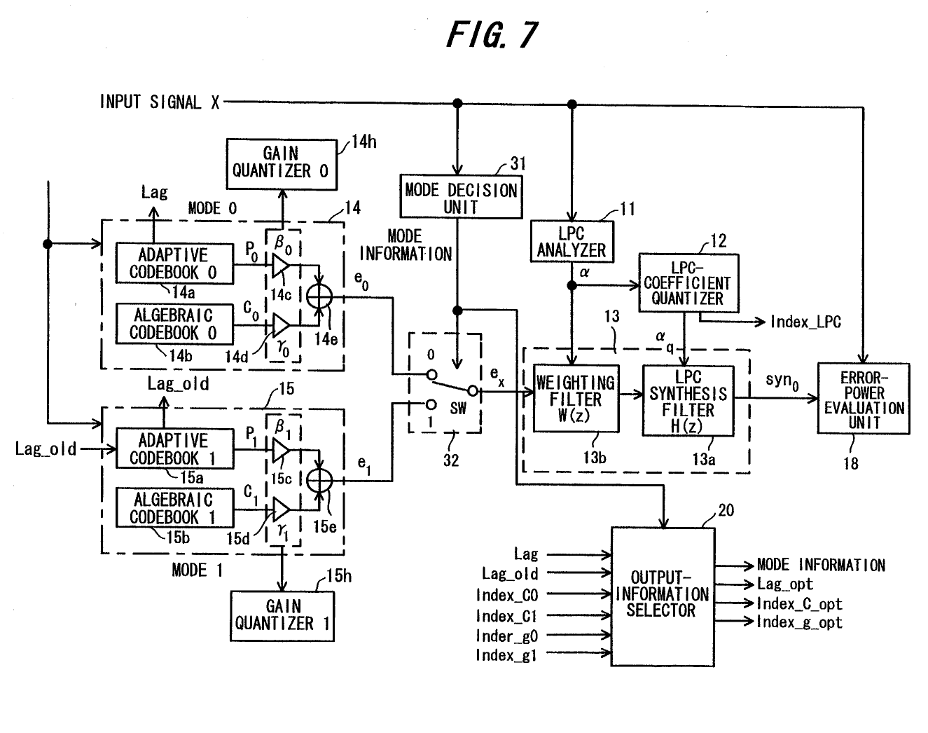

FIG. 7 is a block diagram of a second embodiment of a voice encoding apparatus, in which components identical with those of the first embodiment shown in FIG. 6 are designated by like reference characters. In the first embodiment, an adaptive codebook search and an algebraic codebook search are executed in each mode, the mode that affords the smaller error is decided upon as the mode finally used, the pitch lag Lag_opt, algebraic codebook index Index_C and the gain index Index_g found in this mode are selected and these are transmitted to the decoder. In the second embodiment, however, the properties of the input signal are investigated before the search, which mode is to be adopted is decided in accordance with these properties, and encoding is executed by conducting the adaptive codebook search/algebraic codebook search in whichever mode has been adopted. The second embodiment differs from the first embodiment in that:

(1) a mode decision unit 31 is provided to investigate the properties of the input x before a codebook search and decide which mode to adopt in accordance with the properties of the signal;

(2) a mode-output selector 32 is provided to select the outputs of the encoders 14, 15 conforming to the adopted mode and input the selected output to the weighting filter 13b;

(3) the weighting filter [W(z)] 13b, LPC synthesis filter [H(z)] 13a and error-power evaluation unit 18 are provided in a form shared by each mode; and

(4) the output-information selector 20 selects and transmits information, which is sent to the decoder, based upon mode information that enters from the mode decision unit 31.

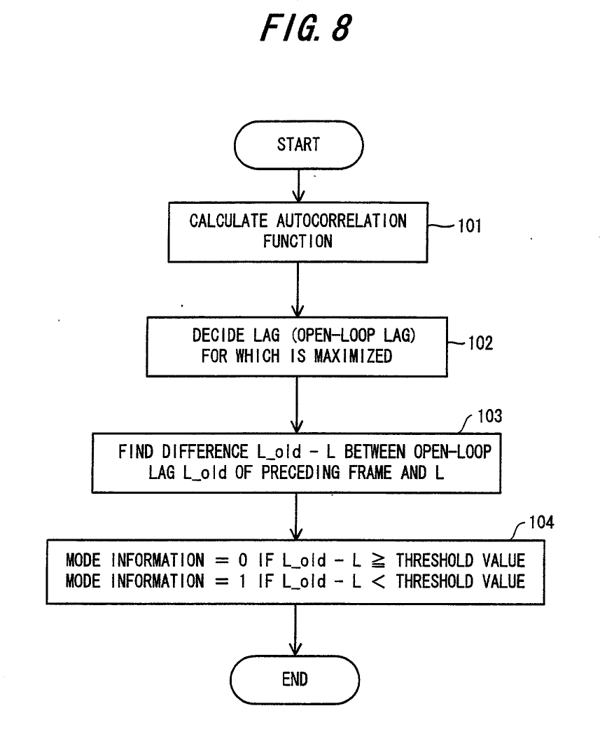

When the input signal vector x is input thereto, the mode decision unit 31 investigates the properties of the input signal x and generates mode information indicating which of the modes 0, 1 should be adopted in accordance with these properties. The mode information becomes 0 if mode 0 is determined to be optimum and becomes mode 1 if mode 1 is determined to be optimum. On the basis of the results of the decision, the mode-output selector 32 selects the output of the first encoder 14 or the output of the second encoder 15. A method of detecting a change in open-loop lag can be used as the method of rendering the mode decision. FIG. 8 shows the processing flow for deciding the mode adopted based upon the properties of the input signal. First, an autocorrelation function R(k) (k=20 to 143) is obtained (step 101) by the following equation using an input signal x(n) (n=0, . . , N-1):

$$R ( k ) = {\sum }_{n = 0}^{N - 1} x ( n ) x ( n - k ) \qquad ( 25 )$$

where N represents the number of samples constituting one frame.

Next, the k for which the autocorrelation function R(k) is maximized is found (step 102). Lag k that prevails when the autocorrelation function R(k) is maximized is referred to as “open-loop lag” and is represented by L. Open-loop lag found similarly in the preceding frame shall be denoted L_old. This is followed by finding the difference (L_old-L) between open-loop lag L old of the preceding frame and open-loop lag L of the present frame (step 103). If (L_old-L) is greater than a predetermined threshold value, then it is construed that the periodicity of input voice has undergone a large change and, hence, the mode information is set to 0. On the other hand, if (L_old-L) is less than the predetermined threshold value, then it is construed that the periodicity of input voice has not changed as compared with the preceding frame and, hence, the mode information is set to 1 (step 104). The above-described processing is thenceforth repeated frame by frame. Furthermore, following the end of mode decision, the open-loop lag L found in the present frame is retained as L_old in order to render the mode decision for the next frame.

The mode-output selector 32 selects a terminal 0 if the mode information is 0 and selects a terminal 1 if the mode information is 1. Accordingly, the two modes do not function simultaneously in the same frame.

If mode 0 is set by the mode decision unit 31, the first encoder 14 conducts a search of the adaptive codebook 14a and of algebraic codebook 14b, after which quantization of pitch gain P₀ and algebraic codebook gain γ₀ is executed by the gain quantizer 14h. The second encoder conforming to mode 1 does not operate at this time.

If mode 1 is set by the mode decision unit 31, on the other hand, the second encoder 15 does not conduct an adaptive codebook search, regards optimum pitch lag lag_old found in a past frame (e.g., the preceding frame) as the optimum lag of the present frame and obtains the optimum pitch gain β₁ that prevails at this time. Next, the second encoder 15 conducts an algebraic codebook search using the algebraic codebook 15b and decides the optimum index I₁ and optimum gain γ₁ that specify the pulsed signal for which error power is minimized. A gain quantizer 15h then executes quantization of the pitch gain β₁ and algebraic codebook gain γ₁. The first encoder 14 on the side of mode 0 does not operate at this time.

In accordance with the second embodiment, in which mode encoding is to be performed is decided based upon the properties of the input signal before a codebook search, encoding is performed in this mode and the result is output. As a result, it is unnecessary to perform encoding in two modes and then select the better result, as is done in the first embodiment. This makes it possible to reduce the amount of processing and enables high-speed processing.

(D) Third Embodiment of Voice Encoding Apparatus

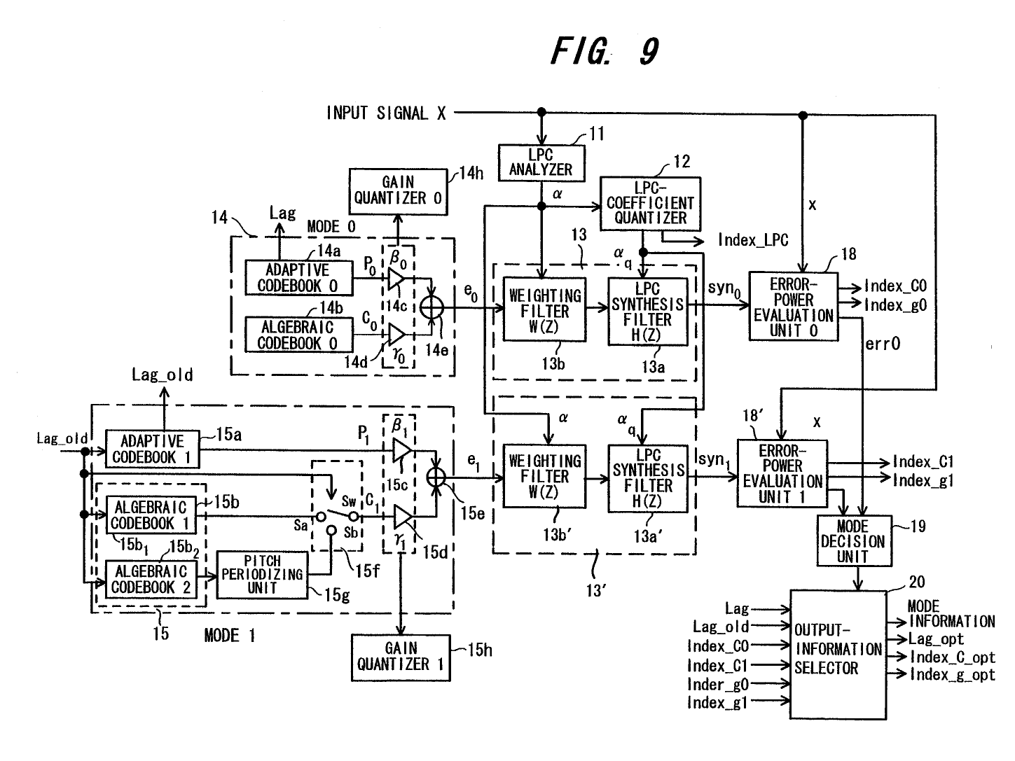

FIG. 9 is a block diagram of a third embodiment of a voice encoding apparatus, in which components identical with those of the first embodiment shown in FIG. 6 are designated by like reference characters. This embodiment differs from the first embodiment in that:

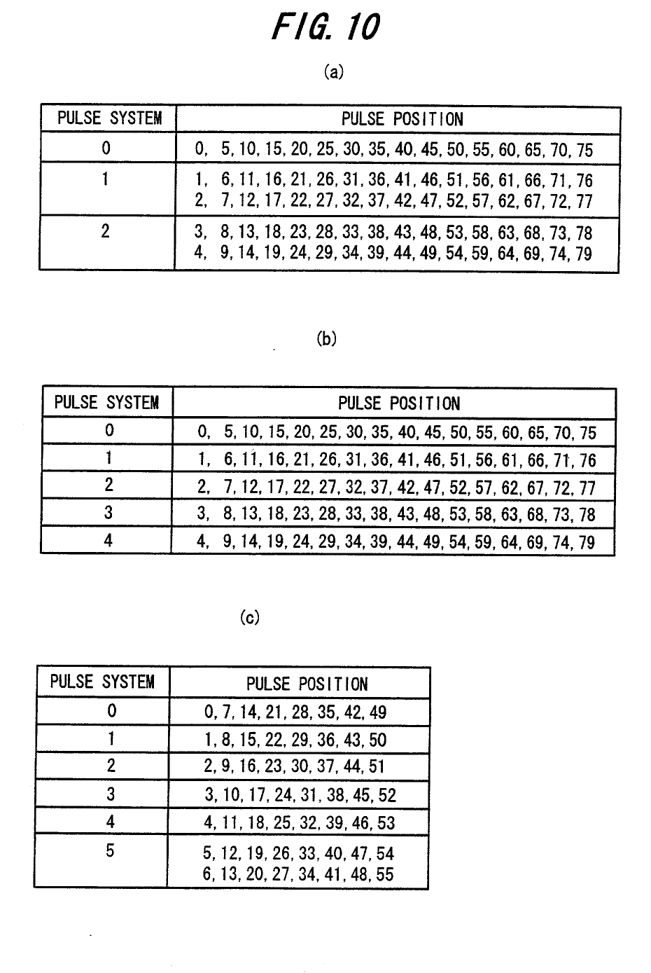

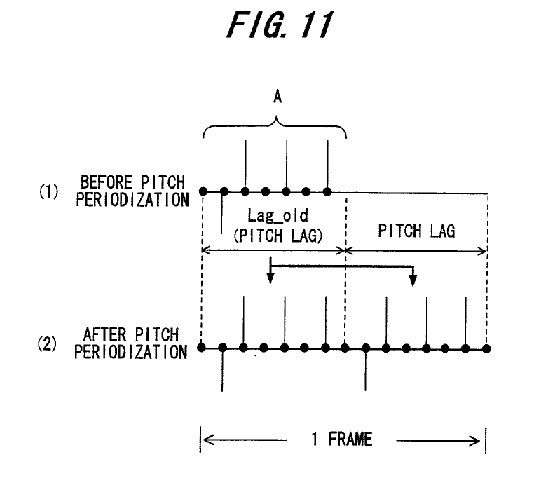

(1) the first algebraic codebook 15b₁ and second algebraic codebook 15b₂ are provided as the algebraic codebook 15b of the second encoder 15, the first algebraic codebook 15b₁ has a pulse placement indicated in (b) of FIG. 10, and the second algebraic codebook 15b₂ has the pulse placement shown in (c) of FIG. 10;

(2) the algebraic codebook changeover unit 15f is provided, selects the pulsed signal, which is the noise component output of the first algebraic codebook 15b₁, if the value Lag_old of pitch lag in the past in mode 1 is greater than a threshold value Th, and selects the pulsed signal output of the second algebraic codebook 15b₂ if the value Lag_old is less than the threshold value Th; and

(3) since the second algebraic codebook 15b₂ places the pulses over a range (sampling points 0 to 55) narrower than that of the first algebraic codebook 15b₁, the pitch periodizing unit 15g is provided and repeatedly generates the pulsed signal, which is output from the second algebraic codebook 15b₂, thereby outputting one frame of the pulsed signal.

In mode 0, the first encoder 14 obtains optimum pitch lag Lag, the algebraic codebook index Index_C0 and the gain index Index_g0 by processing exactly the same as that of the first embodiment.

In mode 1, the second encoder 15 does not conduct a search of the adaptive codebook 15a and uses the optimum pitch lag Lag_old, which was decided in a past frame (e.g., the preceding frame), as the optimum pitch lag of the present frame in a manner similar to that of the first embodiment. The optimum pitch gain is calculated in accordance with Equation (6). Further, when the algebraic codebook search is conducted, the second encoder 15 conducts the search using the first algebraic codebook 15b₁ or second algebraic codebook 15b₂, depending upon the value of the pitch lag Lag_old.

An algebraic codebook search in modes 0 and 1 in a case where frame length is 10 ms and N=80 samples holds will now be described.

(1) Mode 0

An example of pulse placement of the algebraic codebook 14b used in mode 0 is illustrated in FIG. 10(a). This pulse placement is that for a case where the number of pulses is three and the number of quantization bits is 17. Here C₀(n) (n=0, . . . , N-1) indicated by Equation (21) is successively output and an algebraic codebook search similar to that of the prior art is conducted. In Equation (21), sᵢ represents the polarity (+1 or −1) of a pulse-system group i, mᵢ represents the pulse position of the pulse-system group i, and δ (0)=1 holds.

(2) Mode 1

In mode 1, past pitch lag Lag_old is used and therefore quantization bits are not allocated to pitch lag. As a consequence, it is possible to allocate a greater number of bits to the algebraic codebooks 15b₁, 15b₂ than to the algebraic codebook 14b. If the number of quantization bits of pitch lag in mode 0 is eight per frame, then it will be possible to allocate 25 bits (=17+8) as the number of quantization bits of the algebraic codebooks 15b₁, 15b₂.

An example of pulse placement in a case where five pulses reside in one frame at 25 bits is illustrated in (b) of FIG. 10. The first algebraic codebook 15b₁ has this pulse placement and successively outputs pulsed signals having a pulse of a positive polarity or negative polarity at sampling points extracted one at a time from each of the pulse-system groups. Further, an example of pulse placement in a case where six pulses reside in a period of time shorter than the duration of one frame at 25 bits is as shown in (c) of FIG. 10. The second algebraic codebook 15b₂ has this pulse placement and successively outputs pulsed signals having a pulse of a positive polarity or negative polarity at sampling points extracted one at a time from each of the pulse-system groups.

The pulse placement of (b) of FIG. 10 is such that the number of pulses per frame is two greater in comparison with (a) of FIG. 10. The pulse placement of (c) of FIG. 10 is such that the pulses are placed over a narrow range (sampling points 0 to 55); there are three more pulses in comparison with (a) of FIG. 10. In mode 1, therefore, it is possible to encode a sound-source signal more precisely than in mode 0. Further, the second algebraic codebook 15b₂ places pulses over a range (sampling points 0 to 55) narrower than that of the first algebraic codebook 15b₁ but the number of pulses is greater. Consequently, the second algebraic codebook 15b₂ is capable of encoding the sound-source signal more precisely than the first algebraic codebook 15b₁. In mode 1, therefore, if the periodicity of the input signal x is short, a pulsed signal, which is the noise component, is generated using the second algebraic codebook 15b₂. If the periodicity of the input signal x is long, then a pulsed signal that is the noise component is generated using the first algebraic codebook 15b₂.

Thus, in mode 1, if past pitch lag Lag_old is greater than a predetermined threshold value Th (e.g., 55), the output C₁(n) of first algebraic codebook 15b₁ is found in accordance with the following equation:

$${C}_{1} ( n ) = {\sum }_{i = 0}^{4} {s}_{i} δ ( n - {m}_{i} ) \qquad ( 26 )$$

and this output is delivered successively to thereby obtain the algebraic codebook index Index_Cl and gain index Index_g1.

On the other hand, if past pitch lag Lag_old is less than a predetermined threshold value Th (e.g., 55), a search is conducted using the second algebraic codebook 15b₂. The method of searching the second algebraic codebook 15b₂ may be similar to the algebraic codebook search already described, though it is required that impulse response be subjected to pitch periodization before search processing is executed. If the impulse response of the auditory weighting synthesis filter 13 is a(n) (n=0, . . . , 79), then impulse response a′ (n) (n=0, . . . , 79) that has undergone pitch periodization is found by the following equation before the second algebraic codebook 15b₂ is searched:

$${a}^{′} ( n ) = \{ \begin{matrix} a ( n ) & ( n < Lag\_old ) \\ {a}^{′} ( n - Lag\_old ) & ( n \geq Lag\_old )\end{matrix} \qquad ( 27 )$$

In this case, the pitch periodization method will not be only simple repetition; repetition may be performed while decreasing or increasing Lag_old-number of the leading samples at a fixed rate.

The search of the second algebraic codebook 15b₂ is conducted using a′ (n) mentioned above. However, since the output obtained by searching the second algebraic codebook 15b₂ only has pulses from samples 0 to Th (=55), the pitch periodizing unit 15g generates the remaining samples (24 samples in this example) by pitch periodization processing indicated by the following equation:

$${C}_{1} ( n ) = \{ \begin{matrix} {\sum }_{i = 0}^{5} {s}_{i} δ ( n - {m}_{i} ) & ( n < Lag\_old ) \\ {C}_{1} ( n - Lag\_old ) & ( n \geq Lag\_old )\end{matrix} \qquad ( 28 )$$

FIG. 11 is a conceptual view of pitch periodization by the pitch periodizing unit 15g, in which (1) represents a pulsed signal, namely a noise component, prior to the pitch periodization, and (2) represents the pulsed signal after the pitch periodization. The pulsed signal after pitch periodization is obtained by repeating (copying) a noise component A of an amount commensurate with pitch lag Lag_old before pitch periodization. Further, the pitch periodization method will not be only simple repetition; repetition may be performed while decreasing or increasing Lag old-number of the leading samples at a fixed rate.

(c) Algebraic Codebook Changeover

The algebraic codebook changeover unit 15f connects a switch Sw to a terminal Sa if the value of past pitch lag Lag_old is greater than the threshold value Th, whereby the pulsed signal output from the first algebraic codebook 15b₁ is input to the gain multiplier 15d. The latter multiplies the input signal by the algebraic codebook gain γ₁. Further, the algebraic codebook changeover unit 15f connects the switch Sw to a terminal Sb if the value of past pitch lag Lag_old is less than the threshold value Th, whereby the pulsed signal output from the first algebraic codebook 15b₁, which signal has undergone pitch periodization by the pitch periodizing unit 15g, is input to the gain multiplier 15d. The latter multiplies the input signal by the algebraic codebook gain γ_{1.}

The third embodiment is as set forth above. The number of quantization bits and pulse placements illustrated in this embodiment are examples, and various numbers of quantization bits and various pulse placements are possible. Further, though two encoding modes have been described in this embodiment, three or more modes may be used.

Further, the above description is rendered using two adaptive codebooks. However, since exactly the same past sound-source signals are stored in the two adaptive codebooks, implementation is permissible using one of the adaptive codebooks.

Further, in this embodiment, two weighting filters, two LPC synthesis filters and two error-power evaluation units are used. However, these pairs of devices can be united into single common devices and the inputs to the filters may be switched.

Thus, in accordance with the third embodiment, the number of pulses and pulse placement are changed over adaptively in accordance with the value of past pitch lag, thereby making it possible to perform encoding more precisely in comparison with conventional voice encoding and to obtain high-quality reconstructed speech.

(E) Fourth Embodiment of Voice Encoding Apparatus

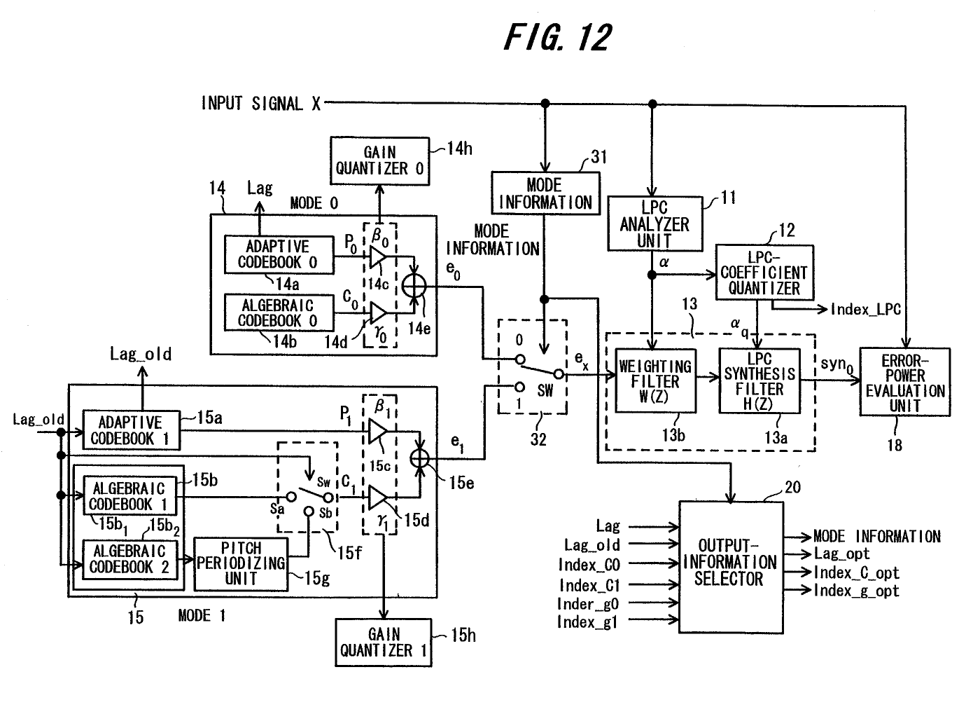

FIG. 12 is a block diagram of a fourth embodiment of a voice encoding apparatus. Here the properties of the input signal are investigated prior to a search, which mode of modes 0, 1 is to be adopted is decided in accordance with these properties, and encoding is performed by conducting the adaptive codebook search/algebraic codebook search in whichever mode has been adopted. The fourth embodiment differs from the third embodiment in that:

(1) the mode decision unit 31 is provided to investigate the properties of the input x before a codebook search and decide which mode to adopt in accordance with the properties of the signal;

(2) the mode-output selector 32 is provided to select the outputs of the encoders 14, 15 conforming to the adopted mode and input the selected output to the weighting filter 13;

(3) the weighting filter [W(z)] 13b, LPC synthesis filter [H(z)] 13a and error-power evaluation unit 18 are provided in a form shared by each mode; and

(4) the output-information selector 20 selects and transmits information, which is sent to the decoder, based upon mode information that enters from the mode decision unit 31.

The mode decision processing executed by the mode decision unit 31 is the same as the processing shown in FIG. 8.

In accordance with the fourth embodiment, in which mode encoding is to be performed is decided based upon the properties of the input signal before a codebook search, encoding is performed in this mode and the result is output. As a result, it is unnecessary to perform encoding in two modes and then select the better result, as is done in the third embodiment. This makes it possible to reduce the amount of processing and enables high-speed processing.

(F) First Embodiment of Decoding Apparatus

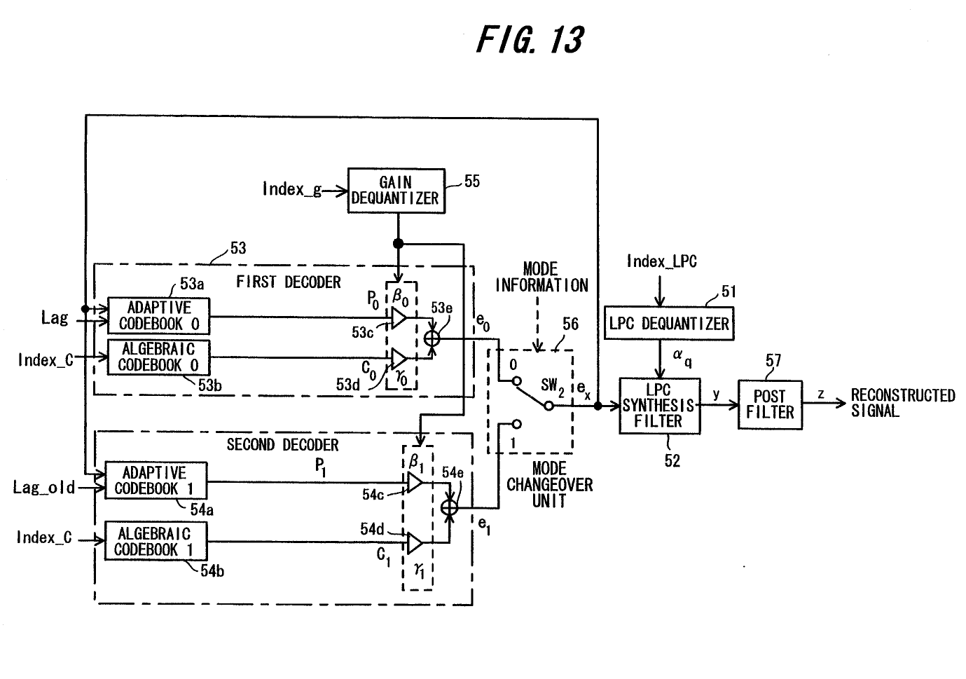

FIG. 13 is a block diagram of a first embodiment of a voice decoding apparatus. This apparatus generates a voice signal by decoding code information sent from the voice encoding apparatus (of the first and second embodiments).

Upon receiving an LPC quantization index Index_LPC from the voice encoding apparatus, an LPC dequantizer 51 outputs a dequantized LPC coefficient α_{q}(i) (i=1, 2, . . . , q), where p represents the degree of LPC analysis. An LPC synthesis filter 52 is a filter having a transfer characteristic indicated by the following equation using the LPC coefficient α_{q}(i):

$$H ( z ) = \frac{1}{1 + {\sum }_{i = 1}^{p} {α}_{q} ( i ) {z}^{- i}} \qquad ( 29 )$$

A first decoder 53 corresponds to the first encoder 14 in the voice encoding apparatus and includes an adaptive codebook 53a, an algebraic codebook 53b, gain multipliers 53c, 53d and an adder 53e. The algebraic codebook 53b has the pulse placement shown in FIG. 2. A second first decoder 54 corresponds to the second encoder 15 in the voice encoding apparatus and includes an adaptive codebook 54a, an algebraic codebook 54b, gain multipliers 54c, 54d and an adder 54e. The algebraic codebook 54b has the pulse placement shown in FIG. 3.

If the mode information of a received present frame is 0, i.e., if mode 0 is selected in the voice encoding apparatus, the pitch lag Lag enters the adaptive codebook 53a of the first decoder and 80 samples of a pitch-period component (adaptive codebook vector) P₀ corresponding to this pitch lag Lag are output by the adaptive codebook 53a. Further, the algebraic codebook index Index_C enters the algebraic codebook 53b of the first decoder and the corresponding noise component (algebraic codebook vector) C₀ is output. The algebraic codebook vector C₀ is generated in accordance with Equation (21). Furthermore, the gain index Index_g enters a gain dequantizer 55 and the dequantized value β₀ of pitch gain and dequantized value γ₀, of algebraic codebook gain enter the multipliers 53c, 53d from the gain dequantizer 55. As a result, a sound-source signal e₀ of mode 0 given by the following equation is output from the adder 53e:

e₀=β₀P₀+γ₀C₀ (30)

If the mode information of the present frame is 1, on the other hand, i.e., if mode 1 is selected in the voice encoding apparatus, the pitch lag Lag_old of the preceding frame enters the adaptive codebook 54a of the second decoder and 80 samples of a pitch-period component (adaptive codebook vector) P₁ corresponding to this pitch lag Lag_old are output by the adaptive codebook 54a. Further, the algebraic codebook index Index_C enters the algebraic codebook 54b of the second decoder and the corresponding noise component (algebraic codebook vector) C₁(n) is generated in accordance with Equation (25). Furthermore, the gain index Index_g enters the gain dequantizer 55 and the dequantized value β₁ of pitch gain and dequantized value γ₁ of algebraic codebook gain enter the multipliers 54c, 54d from the gain dequantizer 55. As a result, a sound-source signal e₁ of mode 1 given by the following equation is output from the adder 54e.

e₁=β₁P₁+γ₁C₁ (31)

A mode changeover unit 56 changes over a switch Sw2 in accordance with the mode information. Specifically, Sw2 is connected to a terminal 0 if the mode information is 0, whereby e₀ becomes the sound-source signal ex. If the mode information is 1, then the switch Sw2 is connected to terminal 1 so that e₁ becomes the sound-source signal ex. The sound-source signal ex is input to the adaptive codebooks 53a, 54a to update the content thereof. That is, the sound-source signal of the oldest frame in the adaptive codebook is discarded and the latest sound-source signal ex found in the present frame is stored.

Further, the sound-source signal ex is input to the LPC synthesis filter 52 constituted by the LPC quantization coefficient α_{q}(i), and the LPC synthesis filter 52 outputs an LPC-synthesized output y. Though the LPC-synthesized output y may be output as reconstructed speech, it is preferred that this signal be passed through a post filter 57 in order to enhance sound quality. The post filter 57 may be of any structure. For example, it is possible to use a post filter in which the transfer function is represented by the following equation:

$$P ( z ) = \frac{1 + {\sum }_{i = 1}^{10} {a}_{i} {\overline{ω}}_{1}^{i} {z}^{- i}}{1 + {\sum }_{i = 1}^{10} {a}_{i} {\overline{ω}}_{2}^{i} {z}^{- i}} ( 1 - μ {z}^{- 1} ) \qquad ( 32 )$$

where ω₁, ω₂, μ₁ are parameters which adjust the characteristics of the post filter. These may take on any values. For example, the following values can be used: ω₁=0.5, ω₂=0.8, μ₁=0.5.

In this embodiment, use of two adaptive codebooks 14a, 15a is described. However, since exactly the same sound-source signals are stored in the two adaptive codebooks, implementation is permissible using one of the adaptive codebooks.

Thus, in accordance with this embodiment, the number of pulses and pulse placement are changed over adaptively in accordance with the value of past pitch lag, thereby making it possible to obtain reconstructed speech of a quality higher than that of the conventional voice decoding apparatus.

(G) Second Embodiment of Decoding Apparatus

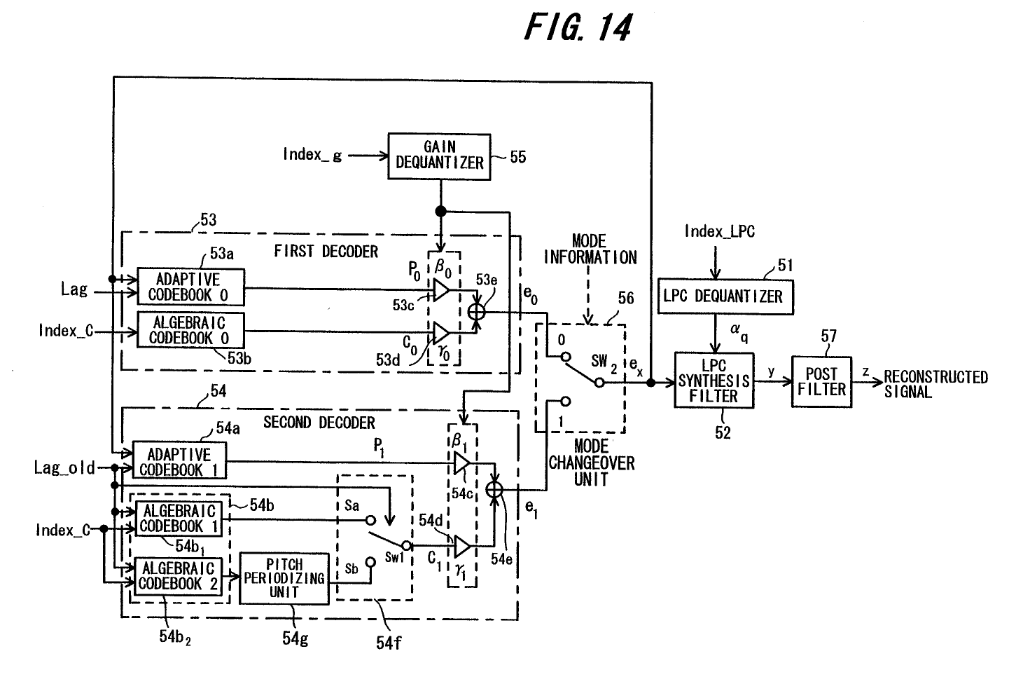

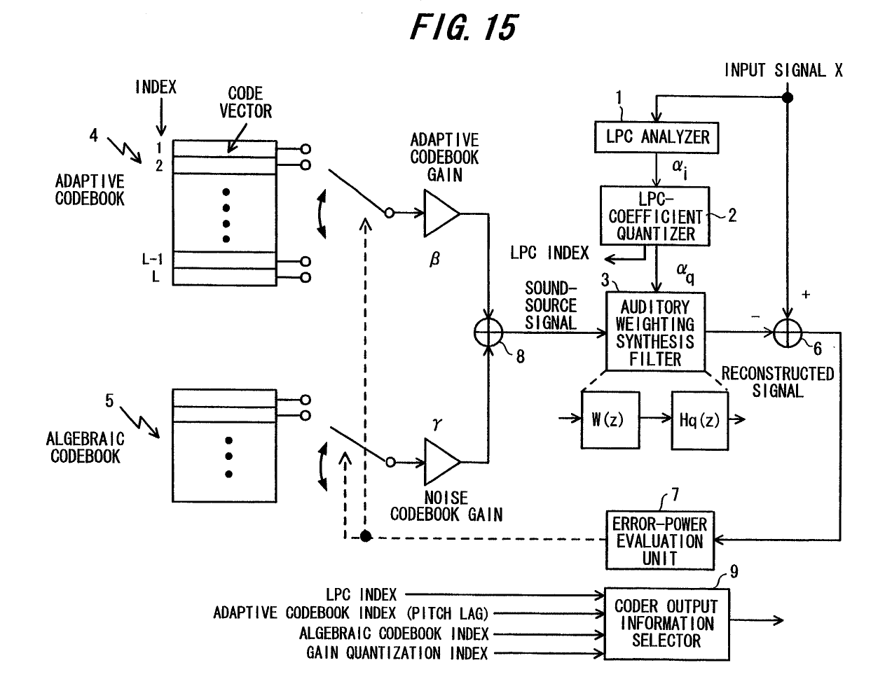

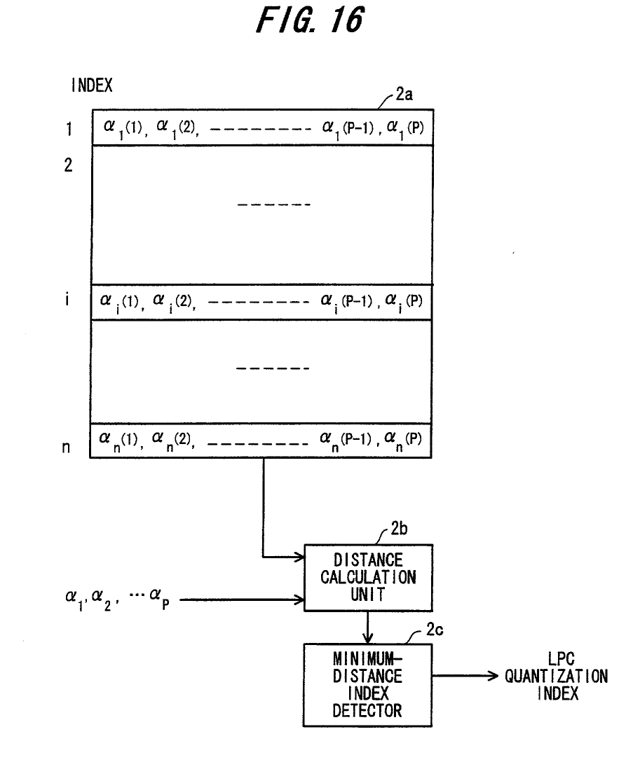

FIG. 14 is a block diagram of a second embodiment of a voice decoding apparatus. This apparatus generates a voice signal by decoding code information sent from the voice encoding apparatus (of the third and fourth embodiments). Components identical with those of the first embodiment in FIG. 13 are designated by like reference characters. This embodiment differs from the first embodiment in that:

(1) a first algebraic codebook 54b₁ and second algebraic codebook 54b₂ are provided as the algebraic codebook 54b, the first algebraic codebook 54b₁ has a pulse placement indicated in FIG. 10(b), and the second algebraic codebook 54b₂ has the pulse placement shown in FIG. 10(c);

(2) an algebraic codebook changeover unit 54f is provided, selects a pulsed signal, which is the noise component output of the first algebraic codebook 54b₁, if the value Lag_old of pitch lag in the past in mode 1 is greater than a threshold value Th, and selects the pulsed signal output of the second algebraic codebook 54b₂ if the value Lag_old is less than the threshold value Th; and

(3) since second algebraic codebook 54b₂ places the pulses over a range (sampling points 0 to 55) narrower than that of the first algebraic codebook 54b₁, a pitch periodizing unit 54g is provided and repeatedly generates the noise component (pulsed signal), which is output from the second algebraic codebook 54b₂, thereby outputting one frame of the pulsed signal.

If the mode information is 0, decoding processing exactly the same as that of the first embodiment is executed. In a case where the mode information is 1, on the other hand, if pitch lag Lag_old of the preceding frame is greater than the predetermined threshold value Th (e.g., 55), the algebraic codebook index Index_C enters the first algebraic codebook 54b₁ and a codebook output C₁(n) is generated in accordance with Equation (25). If pitch lag Lag_old is less than the predetermined threshold value Th, then the algebraic codebook index Index_C enters the first algebraic codebook 54b₂ and a codebook output C₁(n) is generated in accordance with Equation (27). Decoding processing identical with that of the first embodiment is thenceforth executed and a reconstructed speech signal is output from the post filter 57.

Thus, in accordance with this embodiment, the number of pulses and pulse placement are changed over adaptively in accordance with the value of past pitch lag, thereby making it possible to obtain reconstructed speech of a quality higher than that of the conventional voice decoding apparatus.

(H) Effects

In accordance with the present invention, there are provided (1) the conventional CELP mode (mode 0), and (2) a mode (mode 1) in which, by using past pitch lag, the pitch-lag information necessary for an adaptive codebook is reduced while the amount of information in an algebraic codebook is increased. As a result, in unsteady segments, such as unvoiced or transient segments, encoding processing the same as that of conventional CELP can be executed, while in steady segments of speech such as voiced segments, the sound-source signal can be encoded precisely by mode 1, thereby making it possible to obtain high-quality reconstructed voice.

What is claimed is:

1. A voice encoding apparatus for encoding a voice signal using an adaptive codebook and an algebraic codebook, comprising:
a synthesis filter implemented using linear prediction coefficients obtained by subjecting an input signal, which is the result of sampling a voice signal at a predetermined speed, to linear prediction analysis in frame units in which each frame is composed of a fixed number of samples (=N);
an adaptive codebook for preserving a pitch-period component of the past L samples of the voice signal and outputting N samples of periodicity signals successively delayed by one pitch;
an algebraic codebook for dividing N sampling points constituting one frame into a plurality of pulse-system groups and, for all combinations obtained by extracting one sampling point from each of the pulse-system groups, successively outputting, as noise components, pulsed signals having a pulse of a positive or negative polarity at each extracted sampling point;
a pitch-lag determination unit for adopting a pitch lag (first pitch lag) as pitch lag of a present frame, wherein this pitch lag specifies a periodicity signal for which the smallest difference will be obtained between said input signal and signals obtained by driving said synthesis filter by the periodicity signals output successively from the adaptive codebook, or for adopting a pitch lag (second pitch lag), found in a past frame, as pitch lag of the present frame;
a pulsed-signal determination unit for determining a pulsed signal for which the smallest difference will be obtained between said input signal and signals obtained by driving said synthesis filter by the periodicity signal specified by the decided pitch lag and the pulsed signals output successively from the algebraic codebook; and
signal output means for outputting said pitch lag, data specifying said pulsed signal and said linear prediction coefficients as a voice code.

2. A voice encoding apparatus according to claim 1, wherein when the first pitch lag is adopted as the pitch lag of the present frame, said signal output means outputs said first pitch lag, and when the second pitch lag is adopted as the pitch lag of the present frame, said code output means outputs data to this effect;
said algebraic codebook has a first algebraic codebook used when the first pitch lag is adopted as the pitch lag of the present frame, and a second algebraic codebook used when the second pitch lag is adopted as the pitch lag of the present frame; and
the second algebraic codebook has a greater number of pulse-system groups than the first algebraic codebook.

3. A voice encoding apparatus according to claim 2, wherein in that said second algebraic codebook has:
a third algebraic codebook for dividing N sampling points constituting one frame into a plurality of pulse-system groups and, for all combinations obtained by extracting one sampling point from each of the pulse-system groups, successively outputting, as noise components, pulsed signals having a pulse of a positive or negative polarity at each extracted sampling point; and
a fourth algebraic codebook for dividing M sampling points, which are contained in a period of time shorter than the duration of one frame, into a number of pulse-system groups greater than that of the third algebraic codebook and, for all combinations obtained by extracting one sampling point from each of the pulse-system groups, successively outputting, as noise components, pulsed signals having a pulse of a positive or negative polarity at each extracted sampling point;
said pulsed-signal determination unit uses the third algebraic codebook when the value of said second pitch lag is greater than M and uses the fourth algebraic codebook when the value of the second pitch lag is less than M.

4. A voice encoding apparatus according to claim 1, wherein further comprising a pitch-lag selector for selecting said first pitch lag or said second pitch lag as the pitch lag of the present frame in dependence upon properties of the input signal.

5. A voice encoding apparatus according to claim 4, wherein said selector finds a time difference between the input signal of the present frame and a past input signal for which an autocorrelation value is maximized, discriminates periodicity of the input signal on the basis of the time difference, selects the second pitch lag as the pitch lag of the present frame if the periodicity is high and selects the first pitch lag as the pitch lag of the present frame if the periodicity is low.

6. A voice encoding apparatus according to claim 1, wherein further comprising a pitch-lag selector for comparing a difference between the input signal and the signal which is output from the synthesis filter and prevailing when the first pitch lag is used and a difference between the input signal and the signal which is output from the synthesis filter prevailing when the second pitch lag is used, and adopting the pitch lag for which the difference is smaller as the pitch lag of the present frame.

7. A voice encoding method for encoding a voice signal using an adaptive codebook and an algebraic codebook, wherein comprising:
obtaining linear prediction coefficients by subjecting an input signal, which is the result of sampling a voice signal at a predetermined speed, to linear prediction analysis in frame units in which each frame is composed of a fixed number of samples (=N), and constructing a synthesis filter using said linear prediction coefficients;
providing an adaptive codebook for preserving a pitch-period component of the past L samples of the voice signal and successively outputting N samples of periodicity signals delayed by one pitch;
providing a first algebraic codebook for dividing N sampling points constituting one frame into a plurality of pulse-system groups and, for all combinations obtained by extracting one sampling point from each of the pulse-system groups, successively outputting, as noise components, pulsed signals having a pulse of a positive or negative polarity at each extracted sampling point, and a second algebraic codebook for dividing the sampling points into a number of pulse-system groups greater than that of the first algebraic codebook and, for all combinations obtained by extracting one sampling point from each of the pulse-system groups, successively outputting pulsed signals having a pulse of a positive or negative polarity at each extracted sampling point;
adopting, as pitch lag of the present frame, a pitch lag that specifies a periodicity signal for which the smallest difference will be obtained between said input signal and signals obtained by driving said synthesis filter by N samples of periodicity signals obtained from the adaptive codebook upon being successively delayed by one pitch, and specifying a pulsed signal for which the smallest difference (first difference) will be obtained between said input signal and signals obtained by driving said synthesis filter by the periodicity signal specified by the said pitch lag and the pulsed signals output successively from the first algebraic codebook;
adopting a pitch lag, found in a past frame, as pitch lag of the present frame, and specifying a pulsed signal for which the smallest difference (second difference) will be obtained between said input signal and signals obtained by driving said synthesis filter by the periodicity signal specified by said pitch lag and the pulsed signals output successively from the second algebraic codebook; and
outputting, as voice code, the pitch lag and data specifying said pulse signal for whichever of said first and second differences is smaller, and said linear prediction coefficients.

8. A voice encoding method according to claim 7, wherein said second algebraic codebook has:
a third algebraic codebook for dividing N sampling points constituting one frame into a plurality of pulse-system groups and, for all combinations obtained by extracting one sampling point from each of the pulse-system groups, successively outputting, as noise components, pulsed signals having a pulse of a positive or negative polarity at each extracted sampling point; and a fourth algebraic codebook for dividing M sampling points, which are contained in a period of time shorter than the duration of one frame, into a number of pulse-system groups greater than that of the third algebraic codebook and, for all combinations obtained by extracting one sampling point from each of the pulse-system groups, successively outputting, as noise components, pulsed signals having a pulse of a positive or negative polarity at each extracted sampling point; and
the third algebraic codebook is used when the value of said second pitch lag is greater than M, and the fourth algebraic codebook is used when the value of the second pitch lag is less than M, and a pulsed signal is specified so that said second difference is smallest.

9. A voice encoding method for encoding a voice signal using an adaptive codebook and an algebraic codebook, wherein comprising:
obtaining linear prediction coefficients by subjecting an input signal, which is the result of sampling a voice signal at a predetermined speed, to linear prediction analysis in frame units in which each frame is composed of a fixed number of samples (=N), and constructing a synthesis filter using said linear prediction coefficients;
providing an adaptive codebook for preserving a pitch-period component of the past L samples of the voice signal and successively outputting N samples of periodicity signals delayed by one pitch;
providing a first algebraic codebook for dividing N sampling points constituting one frame into a plurality of pulse-system groups and, for all combinations obtained by extracting one sampling point from each of the pulse-system groups, successively outputting, as noise components, pulsed signals having a pulse of a positive or negative polarity at each extracted sampling point, and a second algebraic codebook having a greater number of pulse-system groups than the first algebraic codebook;
(1) if periodicity of the input signal is low,
obtaining a pitch lag that specifies a periodicity signal for which the smallest difference will be obtained between said input signal and signals obtained by driving said synthesis filter by N samples of periodicity signals obtained from the adaptive codebook upon being successively delayed by one pitch;
specifying a pulsed signal for which the smallest difference will be obtained between said input signal and signals obtained by driving said synthesis filter by the periodicity signal specified by said pitch lag and the pulsed signals output successively from the first algebraic codebook; and
outputting said pitch lag, data specifying said pulsed signal and said linear prediction coefficients as a voice code; and
(2) if periodicity of the input signal is high,
adopting a pitch lag, found in a past frame, as pitch lag of the present frame;
specifying a pulsed signal for which the smallest difference will be obtained between said input signal and signals obtained by driving said synthesis filter by the periodicity signal specified by said pitch lag and the pulsed signals output successively from the second algebraic codebook; and
outputting data indicating that pitch lag is identical with past pitch lag, data specifying said pulsed signal and said linear prediction coefficients as a voice code.

10. A voice coding method according to claim 9, wherein said second algebraic codebook has:
a third algebraic codebook for dividing N sampling points constituting one frame into a plurality of pulse-system groups and, for all combinations obtained by extracting one sampling point from each of the pulse-system groups, successively outputting, as noise components, pulsed signals having a pulse of a positive or negative polarity at each extracted sampling point; and a fourth algebraic codebook for dividing M sampling points, which are contained in a period of time shorter than the duration of one frame, into a number of pulse-system groups greater than that of the third algebraic codebook and, for all combinations obtained by extracting one sampling point from each of the pulse-system groups, successively outputting, as noise components, pulsed signals having a pulse of a positive or negative polarity at each extracted sampling point; and
the third algebraic codebook is used when the value of said second pitch lag is greater than M, and the fourth algebraic codebook is used when the value of the second pitch lag is less than M, and a pulsed signal is specified so that said second difference is smallest.

11. A voice encoding method having a synthesis filter implemented using linear prediction coefficients obtained by dividing an input signal into frames each of a fixed length, and subjecting the input signal to linear prediction analysis in the frame units, generating a reconstructed signal by driving said synthesis filter by a periodicity signal output from an adaptive codebook and a pulsed signal output from an algebraic codebook, and performing encoding in such a manner that an error between the input signal and said reproduced signal is minimized, comprising:
providing an encoding mode 1 that uses pitch lag obtained from an input signal of a present frame and an encoding mode 2 that uses pitch lag obtained from an input signal of a past frame;
encoding in accordance with the encoding mode 1 and encoding mode 2 and deciding, frame by frame, the mode in which the input signal can be encoded more precisely; and
adopting the result of the encoding based upon the mode decided.

12. A voice encoding method having a synthesis filter implemented using linear prediction coefficients obtained by dividing an input signal into frames each of a fixed length, and subjecting the input signal to linear prediction analysis in the frame units, generating a reconstructed signal by driving said synthesis filter by a periodicity signal output from an adaptive codebook and a pulsed signal output from an algebraic codebook, and performing encoding in such a manner that an error between the input signal and said reproduced signal is minimized, comprising:
providing an encoding mode 1 that uses pitch lag obtained from an input signal of a present frame and an encoding mode 2 that uses pitch lag obtained from an input signal of a past frame;
deciding an optimum mode in accordance with properties of the input signal; and
performing encoding based upon the mode decided.

13. A voice decoding apparatus for decoding a voice signal using an adaptive codebook and an algebraic codebook, comprising:
a synthesis filter implemented using linear prediction coefficients received from an encoding apparatus;
an adaptive codebook for preserving a pitch-period component of the past L samples of the decoded voice signal and outputting a periodicity signal indicated by pitch lag received from the encoding apparatus or by pitch lag found from information to the effect that pitch lag is the same as in the past;
an algebraic codebook for outputting, as a noise component, a pulsed signal indicated by received data specifying a pulsed signal; and
means for combining, and inputting to said synthesis filter, the periodicity signal output from the adaptive codebook and the pulsed signal output from the algebraic codebook, and outputting a reproduced signal from said synthesis filter.

14. A voice decoding apparatus according to claim 13, wherein said algebraic codebook includes a first algebraic codebook and a second algebraic codebook having a greater number of pulse-system groups than the first algebraic codebook;
if the pitch lag is received from the encoding apparatus, then the first algebraic codebook outputs a pulsed signal indicated by the received data specifying the pulsed signal; and
if the information to the effect that pitch lag is the same as in the past is received from the encoding apparatus, then the second algebraic codebook outputs a pulsed signal indicated by the received data specifying the pulsed signal.

15. A voice decoding apparatus according to claim 14, wherein said second algebraic codebook includes:
a third algebraic codebook for dividing N sampling points constituting one frame into a plurality of pulse-system groups and, for all combinations obtained by extracting one sampling point from each of the pulse-system groups, outputting, as noise components, pulsed signals having a pulse of a positive or negative polarity at each extracted sampling point; and
a fourth algebraic codebook for dividing M sampling points, which are contained in a period of time shorter than the duration of one frame, into a number of pulse-system groups greater than that of the third algebraic codebook and, for all combinations obtained by extracting one sampling point from each of the pulse-system groups, outputting, as noise components, pulsed signals having a pulse of a positive or negative polarity at each extracted sampling point;
if the information to the effect that pitch lag is the same as in the past has been received from the encoding apparatus, then, when the pitch lag is greater than M, the third algebraic codebook outputs the pulsed signal indicated by the received data specifying the pulsed signal, and when the pitch lag is less than M, the fourth algebraic codebook outputs the pulsed signal indicated by the received data specifying the pulsed signal.
